(19) United States
(12) Patent Application Publication
(10) Pub. No.: US 2008/0214708 A1
(43) Pub. Date: Sep. 4, 2008

(54) Asymmetrically substituted phosphinic acids

(75) Inventors: Harald Bauer, Kerpen (DE); Michael Hill, Koeln (DE); Werner Krause, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/904,902

(22) Filed: Sep. 28, 2007

(30) Foreign Application Priority Data
Sep. 28, 2006 (DE) 10 2006 045 814.1

(51) Int. Cl. C07F 9/141; C08K 5/5317

(52) U.S. Cl. 524/147; 568/15

(57) ABSTRACT

The invention relates to asymmetrically substituted phosphinic acids of the formula (I)

R₁R₂C(OH)—P(═O)(OX)—C(OH)R₃R₄ (I)

in which
X is hydrogen
R₁, R₂, R₃, and R₄ are identical or different and are hydrogen, alkyl, alkenyl, alkynyl, aralkyl, aryl and/or alkaryl,
with the proviso that the respective R₁R₂C(OH)— and —C(OH)R₃R₄ groups are always different, to a process for their preparation, and to their use.

The present invention is described in the German priority application No. 10 2006 045 814.1, filed 28, Sep. 2006, which is hereby incorporated by reference as is fully disclosed herein.

The invention relates to asymmetrically substituted phosphinic acids, to a process for their preparation, and to their use.

According to the prior art disclosed hitherto, asymmetrically substituted phosphinic acids such as those corresponding to the formula (I)

R₁R₂C(OH)—P(═O)(OX)—C(OH)R₃R₄ (I)

are inaccessible or accessible only with great difficulty.

According to the prior art, only very inadequate success has been achieved with the preparation of these products. It is possible to bind aldehyde to the material known as Wang resin, and carry out phosphinylation and then P-alkylation, followed by cleavage of the desired products from the Wang resin (Cox. Tetrahedron Letters, 42(1), (2001) 125-128).

An object of the present invention is therefore simply to provide access to asymmetrically substituted phosphinic acids. The object is achieved via asymmetrically substituted phosphinic acids which bear different organic substituents in 1- and 1′-position.

The invention therefore provides asymmetrically substituted phosphinic acids of the formula (I)

R₁R₂C(OH)—P(═O)(OX)—C(OH)R₃R₄ (I)

in which
X is hydrogen
R₁, R₂, R₃, and R₄ are identical or different and are hydrogen, alkyl, alkenyl, alkynyl, aralkyl, aryl and/or alkaryl,
with the proviso that the respective R₁R₂C(OH)— and —C(OH)R₃R₄ groups are always different.

It is preferable that R₁, R₂, R₃, and/or R₄ bear heteroatoms and/or have substitution by a functional group.

It is preferable that the functional groups are carbonyl, aldehyde, carboxy, hydroxy, sulfonic acid, nitrile, cyano, and/or epoxy groups; primary, secondary, and/or tertiary amino groups, and/or unsubstituted, partially substituted, or completely substituted triazines.

It is preferable that the alkyl groups are methyl, ethyl, n-propyl, i-propyl, n-butyl, sec-butyl, tert-butyl, n-octyl and/or ethylhexyl.

It is preferable that the carboxy groups are carboxyalkyl groups of (CH₂)ₙCO₂H where n=1-6 type.

It is preferable that the hydroxy groups are hydroxyalkyl groups of (CH₂)ₙOH where n=1-6 type.

Another object of the present invention is to provide access to a process for preparation of asymmetrically substituted phosphinic acids of the formula (I).

This object is achieved via reaction of a phosphorus source simultaneously or in succession with ketones and/or aldehydes which bear the appropriate substituents.

The invention therefore also provides a process for preparation of asymmetrically substituted phosphinic acids which comprises reacting a phosphorus source simultaneously or in succession with a reactant A and with a reactant B to give an adduct.

It is preferable that the phosphorus source is a salt of hypophosphorous acid, hypophosphorous acid, an ester of hypophosphorous acid, or a mixture thereof.

It is preferable that the salt of hypophosphorous acid is an alkali metal hypophosphite, an alkaline earth metal hypophosphite, a hypophosphite of the elements of the third main group, ammonium hypophosphite, primary, secondary, tertiary, or quaternary alkyl- or arylammonium hypophosphite, triethylammonium hypophosphite, trimethylsilylammonium hypophosphite, and/or N-ethylpiperidine hypophosphite.

It is preferable that the reactant A is a ketone of R₁R₂C═O type or an aldehyde of R₁CHO type, and/or of R₂CHO type, and the reactant B is a ketone of R₃R₄C═O type, or an aldehyde of R₃CHO type, and/or of R₄—CHO type.

It is preferable that the molar ratio of reactant A and, respectively, reactant B to the phosphorus source is from 0.5:1 to 10:1, preferably from 1:1 to 5:1.

The invention further provides the use of the inventive asymmetrically substituted phosphinic acids in flame retardants.

The invention therefore particularly provides the use of asymmetrically substituted phosphinic acids as claimed in one or more of claims 1 to 6 as flame retardants, in particular in clearcoats and intumescent coatings, flame retardant for wood and other cellulose-containing products, as reactive and/or non-reactive flame retardant for polymers, for preparation of flame-retardant polymer molding compositions, for preparation of flame-retardant polymer moldings, and for providing flame retardancy to polyester and unblended or blended cellulose textiles via impregnation.

The invention also provides a flame-retardant thermoplastic polymer molding composition comprising from 0.5 to 45% by weight of asymmetrically substituted phosphinic acids as claimed in at least one of claims 1 to 6, and from 0.5 to 99.5% by weight of thermoplastic polymer, or a mixture of these, where the entirety of the components amounts to 100% by weight.

The invention also provides a flame-retardant thermoset composition, comprising

from 0.1 to 45% by weight of asymmetrically substituted phosphinic acids and at least one of claims 1 to 6, from 40 to 89.9% by weight of unsaturated polyesters, and
from 10 to 60% by weight of vinyl monomer.

Finally, the invention also provides a flame-retardant epoxy resin, comprising

from 0.5 to 50% by weight of asymmetrically substituted phosphinic acids according to at least one of claims 1 to 6, from 5 to 99.5% by weight of an epoxy resin, and from 0 to 20% by weight of a hardener.

In the inventive asymmetrically substituted phosphinic acids, the R₁R₂C(OH)— and —(COH)R₃R₄ groups are always different. This also applies correspondingly to components A and B.

If R₁, R₂, R₃, and R₄ are alkyl, alkenyl, alkynyl, aralkyl, aryl or alkaryl, these groups can, if appropriate, be linear, branched, or cyclic, or else part of a ring system.

Substituted phenyl is also suitable, preferably mono-, bis, and/or trisubstituted hydroxy-, amino-, N-alkylamino-, or N,N-dialkylaminophenyl.

The following asymmetrically substituted phosphinic acids are inventive compounds:
(H)(H)C(OH)—P(═O)(OH)—C(OH)(H)(alkyl),
(H)(H)C(OH)—P(═O)(OH)—C(OH)(H)(aryl),
(H)(H)C(OH)—P(═O)(OH)—C(OH)(H)(carboxyalkyl),
(H)(H)C(OH)—P(═O)(OH)—C(OH)(alkyl)(alkyl),
(H)(H)C(OH)—P(═O)(OH)—C(OH)(aryl)(alkyl),
(H)(H)C(OH)—P(═O)(OH)—C(OH)(carboxyalkyl)(alkyl),
(H)(H)C(OH)—P(═O)(OH)—C(OH)(aryl)(aryl),
(H)(H)C(OH)—P(═O)(OH)—C(OH)(aryl)(carboxyalkyl),
(H)(H)C(OH)—P(═O)(OH)—C(OH)(carboxyalkyl)(carboxyalkyl),
(H)(aryl)C(OH)—P(═O)(OH)—C(OH)(H)(alkyl),
(H)(carboxyalkyl)C(OH)—P(═O)(OH)—C(OH)(H)(alkyl),
(H)(alkyl)C(OH)—P(═O)(OH)—C(OH)(H)(aryl),
(H)(alkyl)C(OH)—P(═O)(OH)—C(OH)(H)(carboxyalkyl),
(H)(aryl)C(OH)—P(═O)(OH)—C(OH)(H)(carboxyalkyl),
(H)(H)C(OH)—P(═O)(OH)—C(OH)(alkyl)(alkyl),
(H)(alkyl)C(OH)—P(═O)(OH)—C(OH)(alkyl)(alkyl),
(H)(aryl)C(OH)—P(═O)(OH)—C(OH)(alkyl)(alkyl),
(H)(carboxyalkyl)C(OH)—P(═O)(OH)—C(OH)(alkyl)(alkyl),
(H)(H)C(OH)—P(═O)(OH)—C(OH)(aryl)(alkyl),
(H)(alkyl)C(OH)—P(═O)(OH)—C(OH)(aryl)(alkyl),
(H)(aryl)C(OH)—P(═O)(OH)—C(OH)(aryl)(alkyl),
(H)(carboxyalkyl)C(OH)—P(═O)(OH)—C(OH)(aryl)(alkyl),
(H)(H)C(OH)—P(═O)(OH)—C(OH)(carboxyalkyl)(alkyl),
(H)(alkyl)C(OH)—P(═O)(OH)—C(OH)(carboxyalkyl)(alkyl),
(H)(aryl)C(OH)—P(═O)(OH)—C(OH)(carboxyalkyl)(alkyl),
(H)(carboxyalkyl)C(OH)—P(═O)(OH)—C(OH)(carboxyalkyl)(alkyl),
(H)(H)C(OH)—P(═O)(OH)—C(OH)(aryl)(aryl),
(H)(alkyl)C(OH)—P(═O)(OH)—C(OH)(aryl)(aryl),
(H)(aryl)C(OH)—P(═O)(OH)—C(OH)(aryl)(aryl),
(H)(carboxyalkyl)C(OH)—P(═O)(OH)—C(OH)(aryl)(aryl),
(H)(H)C(OH)—P(═O)(OH)—C(OH)(aryl)(carboxyalkyl),
(H)(alkyl)C(OH)—P(═O)(OH)—C(OH)(aryl)(carboxyalkyl),
(H)(aryl)C(OH)—P(═O)(OH)—C(OH)(aryl)(carboxyalkyl),
(H)(carboxyalkyl)C(OH)—P(═O)(OH)—C(OH)(aryl)(carboxyalkyl),
(H)(H)C(OH)—P(═O)(OH)—C(OH)(carboxyalkyl)(carboxyalkyl),
(H)(alkyl)C(OH)—P(═O)(OH)—C(OH)(carboxyalkyl)(carboxyalkyl),
(H)(aryl)C(OH)—P(═O)(OH)—C(OH)(carboxyalkyl)(carboxyalkyl),
(H)(carboxyalkyl)C(OH)—P(═O)(OH)—C(OH)(carboxyalkyl)(carboxyalkyl),
(aryl)(alkyl)C(OH)—P(═O)(OH)—C(OH)(alkyl)(alkyl),
(carboxyalkyl)(alkyl)C(OH)—P(═O)(OH)—C(OH)(alkyl)(alkyl),
(alkyl)(aryl)C(OH)—P(═O)(OH)—C(OH)(alkyl)(alkyl),
(aryl)(aryl)C(OH)—P(═O)(OH)—C(OH)(alkyl)(alkyl),
(carboxyalkyl)(aryl)C(OH)—P(═O)(OH)—C(OH)(alkyl)(alkyl),
(alkyl)(carboxyalkyl)C(OH)—P(═O)(OH)—C(OH)(alkyl)(alkyl),
(aryl)(carboxyalkyl)C(OH)—P(═O)(OH)—C(OH)(alkyl)(alkyl),
(carboxyalkyl)(carboxyalkyl)C(OH)—P(═O)(OH)—C(OH)(alkyl)(alkyl),
(alkyl)(H)C(OH)—P(═O)(OH)—C(OH)(aryl)(alkyl),
(aryl)(H)C(OH)—P(═O)(OH)—C(OH)(aryl)(alkyl),
(carboxyalkyl)(H)C(OH)—P(═O)(OH)—C(OH)(aryl)(alkyl),
(alkyl)(alkyl)C(OH)—P(═O)(OH)—C(OH)(aryl)(alkyl),
(carboxyalkyl)(alkyl)C(OH)—P(═O)(OH)—C(OH)(aryl)(alkyl),
(aryl)(aryl)C(OH)—P(═O)(OH)—C(OH)(aryl)(alkyl),
(alkyl)(carboxyalkyl)C(OH)—P(═O)(OH)—C(OH)(aryl)(alkyl),
(aryl)(carboxyalkyl)C(OH)—P(═O)(OH)—C(OH)(aryl)(alkyl),
(carboxyalkyl)(carboxyalkyl)C(OH)—P(═O)(OH)—C(OH)(aryl)(alkyl),
(alkyl)(H)C(OH)—P(═O)(OH)—C(OH)(carboxyalkyl)(alkyl),
(aryl)(H)C(OH)—P(═O)(OH)—C(OH)(carboxyalkyl)(alkyl),
(carboxyalkyl)(H)C(OH)—P(═O)(OH)—C(OH)(carboxyalkyl)(alkyl),
(aryl)(aryl)C(OH)—P(═O)(OH)—C(OH)(carboxyalkyl)(alkyl),
(aryl)(carboxyalkyl)C(OH)—P(═O)(OH)—C(OH)(carboxyalkyl)(alkyl),
(carboxyalkyl)(carboxyalkyl)C(OH)—P(═O)(OH)—C(OH)(carboxyalkyl)(alkyl),
(alkyl)(H)C(OH)—P(═O)(OH)—C(OH)(aryl)(aryl),
(aryl)(H)C(OH)—P(═O)(OH)—C(OH)(aryl)(aryl),
(carboxyalkyl)(H)C(OH)—P(═O)(OH)—C(OH)(aryl)(aryl),
(aryl)(alkyl)C(OH)—P(═O)(OH)—C(OH)(aryl)(aryl),
(carboxyalkyl)(aryl)C(OH)—P(═O)(OH)—C(OH)(aryl)(aryl),
(alkyl)(carboxyalkyl)C(OH)—P(═O)(OH)—C(OH)(aryl)(aryl),
(aryl)(carboxyalkyl)C(OH)—P(═O)(OH)—C(OH)(aryl)(aryl),
(carboxyalkyl)(carboxyalkyl)C(OH)—P(═O)(OH)—C(OH)(aryl)(aryl),
(alkyl)(H)C(OH)—P(═O)(OH)—C(OH)(aryl)(carboxyalkyl),
(aryl)(H)C(OH)—P(═O)(OH)—C(OH)(aryl)(carboxyalkyl),
(carboxyalkyl)(H)C(OH)—P(═O)(OH)—C(OH)(aryl)(carboxyalkyl),
(aryl)(alkyl)C(OH)—P(═O)(OH)—C(OH)(aryl)(carboxyalkyl),
(carboxyalkyl)(alkyl)C(OH)—P(═O)(OH)—C(OH)(aryl)(carboxyalkyl),
(carboxyalkyl)(carboxyalkyl)C(OH)—P(═O)(OH)—C(OH)(aryl)(carboxyalkyl),
(alkyl)(H)C(OH)—P(═O)(OH)—C(OH)(carboxyalkyl)(carboxyalkyl),
(aryl)(H)C(OH)—P(═O)(OH)—C(OH)(carboxyalkyl)(carboxyalkyl),
(carboxyalkyl)(H)C(OH)—P(═O)(OH)—C(OH)(carboxyalkyl)(carboxyalkyl),
(alkyl)(alkyl)C(OH)—P(═O)(OH)—C(OH)(carboxyalkyl)(carboxyalkyl),
(aryl)(alkyl)C(OH)—P(═O)(OH)—C(OH)(carboxyalkyl)(carboxyalkyl),
(carboxyalkyl)(alkyl)C(OH)—P(═O)(OH)—C(OH)(carboxyalkyl)(carboxyalkyl),
(alkyl)(aryl)C(OH)—P(═O)(OH)—C(OH)(carboxyalkyl)(carboxyalkyl),
(aryl)(aryl)C(OH)—P(═O)(OH)—C(OH)(carboxyalkyl)(carboxyalkyl),
(carboxyalkyl)(aryl)C(OH)—P(═O)(OH)—C(OH)(carboxyalkyl)(carboxyalkyl),
(alkyl)(carboxyalkyl)C(OH)—P(═O)(OH)—C(OH)(carboxyalkyl)(carboxyalkyl),
(aryl)(carboxyalkyl)C(OH)—P(═O)(OH)—C(OH)(carboxyalkyl)(carboxyalkyl),
(carboxyalkyl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(cycloalkyl),
(H)(H)C(OH)—P(═O)(OH)—C(OH)(cycloalkyl)(cycloalkyl),
(H)(H)C(OH)—P(═O)(OH)—C(OH)(aryl)(cycloalkyl),
(H)(H)C(OH)—P(═O)(OH)—C(OH)(carboxyalkyl)(cycloalkyl),
(H)(aryl)C(OH)—P(═O)(OH)—C(OH)(H)(cycloalkyl),
(H)(carboxyalkyl)C(OH)—P(═O)(OH)—C(OH)(H)(cycloalkyl),
(H)(cycloalkyl)C(OH)—P(═O)(OH)—C(OH)(H)(aryl),
(H)(cycloalkyl)C(OH)—P(═O)(OH)—C(OH)(H)(carboxyalkyl),
(H)(H)C(OH)—P(═O)(OH)—C(OH)(cycloalkyl)(cycloalkyl),
(H)(cycloalkyl)C(OH)—P(═O)(OH)—C(OH)(cycloalkyl)(cycloalkyl),
(H)(aryl)C(OH)—P(═O)(OH)—C(OH)(cycloalkyl)(cycloalkyl),
(H)(carboxyalkyl)C(OH)—P(═O)(OH)—C(OH)(cycloalkyl)(cycloalkyl),
(H)(H)C(OH)—P(═O)(OH)—C(OH)(aryl)(cycloalkyl),
(H)(cycloalkyl)C(OH)—P(═O)(OH)—C(OH)(aryl)(cycloalkyl),
(H)(aryl)C(OH)—P(═O)(OH)—C(OH)(aryl)(cycloalkyl),
(H)(carboxyalkyl)C(OH)—P(═O)(OH)—C(OH)(aryl)(cycloalkyl),
(H)(H)C(OH)—P(═O)(OH)—C(OH)(carboxyalkyl)(cycloalkyl),
(H)(cycloalkyl)C(OH)—P(═O)(OH)—C(OH)(carboxyalkyl)(cycloalkyl),
(H)(aryl)C(OH)—P(═O)(OH)—C(OH)(carboxyalkyl)(cycloalkyl),
(H)(carboxyalkyl)C(OH)—P(═O)(OH)—C(OH)(carboxyalkyl)(cycloalkyl),
(H)(cycloalkyl)C(OH)—P(═O)(OH)—C(OH)(aryl)(aryl),
(H)(cycloalkyl)C(OH)—P(═O)(OH)—C(OH)(aryl)(carboxyalkyl),
(H)(cycloalkyl)C(OH)—P(═O)(OH)—C(OH)(carboxyalkyl)(carboxyalkyl),
(aryl)(cycloalkyl)C(OH)—P(═O)(OH)—C(OH)(cycloalkyl)(cycloalkyl),
(carboxyalkyl)(cycloalkyl)C(OH)—P(═O)(OH)—C(OH)(cycloalkyl)(cycloalkyl),
(cycloalkyl)(aryl)C(OH)—P(═O)(OH)—C(OH)(cycloalkyl)(cycloalkyl),
(aryl)(aryl)C(OH)—P(═O)(OH)—C(OH)(cycloalkyl)(cycloalkyl),
(carboxyalkyl)(aryl)C(OH)—P(═O)(OH)—C(OH)(cycloalkyl)(cycloalkyl),
(cycloalkyl)(carboxyalkyl)C(OH)—P(═O)(OH)—C(OH)(cycloalkyl)(cycloalkyl),
(aryl)(carboxyalkyl)C(OH)—P(═O)(OH)—C(OH)(cycloalkyl)(cycloalkyl),
(carboxyalkyl)(carboxyalkyl)C(OH)—P(═O)(OH)—C(OH)(cycloalkyl)(cycloalkyl),
(cycloalkyl)(H)C(OH)—P(═O)(OH)—C(OH)(aryl)(cycloalkyl),
(aryl)(H)C(OH)—P(═O)(OH)—C(OH)(aryl)(cycloalkyl),
(carboxyalkyl)(H)C(OH)—P(═O)(OH)—C(OH)(aryl)(cycloalkyl),
(cycloalkyl)(cycloalkyl)C(OH)—P(═O)(OH)—C(OH)(aryl)(cycloalkyl),
(carboxyalkyl)(cycloalkyl)C(OH)—P(═O)(OH)—C(OH)(aryl)(cycloalkyl),
(aryl)(aryl)C(OH)—P(═O)(OH)—C(OH)(aryl)(cycloalkyl),
(cycloalkyl)(carboxyalkyl)C(OH)—P(═O)(OH)—C(OH)(aryl)(cycloalkyl),
(aryl)(carboxyalkyl)C(OH)—P(═O)(OH)—C(OH)(aryl)(cycloalkyl),
(carboxyalkyl)(carboxyalkyl)C(OH)—P(═O)(OH)—C(OH)(aryl)(cycloalkyl),
(cycloalkyl)(H)C(OH)—P(═O)(OH)—C(OH)(carboxyalkyl)(cycloalkyl),
(aryl)(H)C(OH)—P(═O)(OH)—C(OH)(carboxyalkyl)(cycloalkyl),
(carboxyalkyl)(H)C(OH)—P(═O)(OH)—C(OH)(carboxyalkyl)(cycloalkyl),
(aryl)(aryl)C(OH)—P(═O)(OH)—C(OH)(carboxyalkyl)(cycloalkyl),
(aryl)(carboxyalkyl)C(OH)—P(═O)(OH)—C(OH)(carboxyalkyl)(cycloalkyl),
(carboxyalkyl)(carboxyalkyl)C(OH)—P(═O)(OH)—C(OH)(carboxyalkyl)(cycloalkyl),
(cycloalkyl)(H)C(OH)—P(═O)(OH)—C(OH)(aryl)(aryl),
(aryl)(cycloalkyl)C(OH)—P(═O)(OH)—C(OH)(aryl)(aryl),
(cycloalkyl)(carboxyalkyl)C(OH)—P(═O)(OH)—C(OH)(aryl)(aryl),
(cycloalkyl)(H)C(OH)—P(═O)(OH)—C(OH)(aryl)(carboxyalkyl),
(aryl)(cycloalkyl)C(OH)—P(═O)(OH)—C(OH)(aryl)(carboxyalkyl),
(carboxyalkyl)(cycloalkyl)C(OH)—P(═O)(OH)—C(OH)(aryl)(carboxyalkyl),
(cycloalkyl)(H)C(OH)—P(═O)(OH)—C(OH)(carboxyalkyl)(carboxyalkyl),
(cycloalkyl)(cycloalkyl)C(OH)—P(═O)(OH)—C(OH)(carboxyalkyl)(carboxyalkyl),
(aryl)(cycloalkyl)C(OH)—P(═O)(OH)—C(OH)(carboxyalkyl)(carboxyalkyl),
(carboxyalkyl)(cycloalkyl)C(OH)—P(═O)(OH)—C(OH)(carboxyalkyl)(carboxyalkyl),
(cycloalkyl)(aryl)C(OH)—P(═O)(OH)—C(OH)(carboxyalkyl)(carboxyalkyl),
(cycloalkyl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(alkenyl),
(H)(H)C(OH)—P(═O)(OH)—C(OH)(alkenyl)(alkenyl),
(H)(H)C(OH)—P(═O)(OH)—C(OH)(aryl)(alkenyl),
(H)(H)C(OH)—P(═O)(OH)—C(OH)(carboxyalkyl)(alkenyl),
(H)(aryl)C(OH)—P(═O)(OH)—C(OH)(H)(alkenyl),
(H)(carboxyalkyl)C(OH)—P(═O)(OH)—C(OH)(H)(alkenyl),
(H)(alkenyl)C(OH)—P(═O)(OH)—C(OH)(H)(aryl),
(H)(alkenyl)C(OH)—P(═O)(OH)—C(OH)(H)(carboxyalkyl),
(H)(H)C(OH)—P(═O)(OH)—C(OH)(alkenyl)(alkenyl),
(H)(alkenyl)C(OH)—P(═O)(OH)—C(OH)(alkenyl)(alkenyl),
(H)(aryl)C(OH)—P(═O)(OH)—C(OH)(alkenyl)(alkenyl),
(H)(carboxyalkyl)C(OH)—P(═O)(OH)—C(OH)(alkenyl)(alkenyl),
(H)(H)C(OH)—P(═O)(OH)—C(OH)(aryl)(alkenyl),
(H)(alkenyl)C(OH)—P(═O)(OH)—C(OH)(aryl)(alkenyl),
(H)(aryl)C(OH)—P(═O)(OH)—C(OH)(aryl)(alkenyl),
(H)(carboxyalkyl)C(OH)—P(═O)(OH)—C(OH)(aryl)(alkenyl),
(H)(H)C(OH)—P(═O)(OH)—C(OH)(carboxyalkyl)(alkenyl),
(H)(alkenyl)C(OH)—P(═O)(OH)—C(OH)(carboxyalkyl)(alkenyl),
(H)(aryl)C(OH)—P(═O)(OH)—C(OH)(carboxyalkyl)(alkenyl),
(H)(carboxyalkyl)C(OH)—P(═O)(OH)—C(OH)(carboxyalkyl)(alkenyl),
(H)(alkenyl)C(OH)—P(═O)(OH)—C(OH)(aryl)(aryl),
(H)(alkenyl)C(OH)—P(═O)(OH)—C(OH)(aryl)(carboxyalkyl),
(H)(alkenyl)C(OH)—P(═O)(OH)—C(OH)(carboxyalkyl)(carboxyalkyl),
(aryl)(alkenyl)C(OH)—P(═O)(OH)—C(OH)(alkenyl)(alkenyl),
(carboxyalkyl)(alkenyl)C(OH)—P(═O)(OH)—C(OH)(alkenyl)(alkenyl),
(alkenyl)(aryl)C(OH)—P(═O)(OH)—C(OH)(alkenyl)(alkenyl),
(aryl)(aryl)C(OH)—P(═O)(OH)—C(OH)(alkenyl)(alkenyl),
(carboxyalkyl)(aryl)C(OH)—P(═O)(OH)—C(OH)(alkenyl)(alkenyl),
(alkenyl)(carboxyalkyl)C(OH)—P(═O)(OH)—C(OH)(alkenyl)(alkenyl),
(aryl)(carboxyalkyl)C(OH)—P(═O)(OH)—C(OH)(alkenyl)(alkenyl),
(carboxyalkyl)(carboxyalkyl)C(OH)—P(═O)(OH)—C(OH)(alkenyl)(alkenyl),
(alkenyl)(H)C(OH)—P(═O)(OH)—C(OH)(aryl)(alkenyl),
(aryl)(H)C(OH)—P(═O)(OH)—C(OH)(aryl)(alkenyl),
(carboxyalkyl)(H)C(OH)—P(═O)(OH)—C(OH)(aryl)(alkenyl),
(alkenyl)(alkenyl)C(OH)—P(═O)(OH)—C(OH)(aryl)(alkenyl),
(carboxyalkyl)(alkenyl)C(OH)—P(═O)(OH)—C(OH)(aryl)(alkenyl),
(aryl)(aryl)C(OH)—P(═O)(OH)—C(OH)(aryl)(alkenyl),
(alkenyl)(carboxyalkyl)C(OH)—P(═O)(OH)—C(OH)(aryl)(alkenyl),
(aryl)(carboxyalkyl)C(OH)—P(═O)(OH)—C(OH)(aryl)(alkenyl),
(carboxyalkyl)(carboxyalkyl)C(OH)—P(═O)(OH)—C(OH)(aryl)(alkenyl),
(alkenyl)(H)C(OH)—P(═O)(OH)—C(OH)(carboxyalkyl)(alkenyl),
(aryl)(H)C(OH)—P(═O)(OH)—C(OH)(carboxyalkyl)(alkenyl),
(carboxyalkyl)(H)C(OH)—P(═O)(OH)—C(OH)(carboxyalkyl)(alkenyl),
(aryl)(aryl)C(OH)—P(═O)(OH)—C(OH)(carboxyalkyl)(alkenyl),
(aryl)(carboxyalkyl)C(OH)—P(═O)(OH)—C(OH)(carboxyalkyl)(alkenyl),
(carboxyalkyl)(carboxyalkyl)C(OH)—P(═O)(OH)—C(OH)(carboxyalkyl)(alkenyl),
(alkenyl)(H)C(OH)—P(═O)(OH)—C(OH)(aryl)(aryl),
(aryl)(alkenyl)C(OH)—P(═O)(OH)—C(OH)(aryl)(aryl),
(alkenyl)(carboxyalkyl)C(OH)—P(═O)(OH)—C(OH)(aryl)(aryl),
(alkenyl)(H)C(OH)—P(═O)(OH)—C(OH)(aryl)(carboxyalkyl),
(aryl)(alkenyl)C(OH)—P(═O)(OH)—C(OH)(aryl)(carboxyalkyl),
(carboxyalkyl)(alkenyl)C(OH)—P(═O)(OH)—C(OH)(aryl)(carboxyalkyl),
(alkenyl)(H)C(OH)—P(═O)(OH)—C(OH)(carboxyalkyl)(carboxyalkyl),
(alkenyl)(alkenyl)C(OH)—P(═O)(OH)—C(OH)(carboxyalkyl)(carboxyalkyl),
(aryl)(alkenyl)C(OH)—P(═O)(OH)—C(OH)(carboxyalkyl)(carboxyalkyl),
(carboxyalkyl)(alkenyl)C(OH)—P(═O)(OH)—C(OH)(carboxyalkyl)(carboxyalkyl),
(alkenyl)(aryl)C(OH)—P(═O)(OH)—C(OH)(carboxyalkyl)(carboxyalkyl),
(alkenyl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(alkynyl),
(H)(H)C(OH)—P(═O)(OH)—C(OH)(alkynyl)(alkynyl),
(H)(H)C(OH)—P(═O)(OH)—C(OH)(aryl)(alkynyl),
(H)(H)C(OH)—P(═O)(OH)—C(OH)(carboxyalkyl)(alkynyl),
(H)(aryl)C(OH)—P(═O)(OH)—C(OH)(H)(alkynyl),
(H)(carboxyalkyl)C(OH)—P(═O)(OH)—C(OH)(H)(alkynyl),
(H)(alkynyl)C(OH)—P(═O)(OH)—C(OH)(H)(aryl),
(H)(alkynyl)C(OH)—P(═O)(OH)—C(OH)(H)(carboxyalkyl),
(H)(H)C(OH)—P(═O)(OH)—C(OH)(alkynyl)(alkynyl),
(H)(alkynyl)C(OH)—P(═O)(OH)—C(OH)(alkynyl)(alkynyl),
(H)(aryl)C(OH)—P(═O)(OH)—C(OH)(alkynyl)(alkynyl),
(H)(carboxyalkyl)C(OH)—P(═O)(OH)—C(OH)(alkynyl)(alkynyl),
(H)(H)C(OH)—P(═O)(OH)—C(OH)(aryl)(alkynyl),
(H)(alkynyl)C(OH)—P(═O)(OH)—C(OH)(aryl)(alkynyl),
(H)(aryl)C(OH)—P(═O)(OH)—C(OH)(aryl)(alkynyl),
(H)(carboxyalkyl)C(OH)—P(═O)(OH)—C(OH)(aryl)(alkynyl),
(H)(H)C(OH)—P(═O)(OH)—C(OH)(carboxyalkyl)(alkynyl),
(H)(alkynyl)C(OH)—P(═O)(OH)—C(OH)(carboxyalkyl)(alkynyl),
(H)(aryl)C(OH)—P(═O)(OH)—C(OH)(carboxyalkyl)(alkynyl),
(H)(carboxyalkyl)C(OH)—P(═O)(OH)—C(OH)(carboxyalkyl)(alkynyl),
(H)(alkynyl)C(OH)—P(═O)(OH)—C(OH)(aryl)(aryl),
(H)(alkynyl)C(OH)—P(═O)(OH)—C(OH)(aryl)(carboxyalkyl),
(H)(alkynyl)C(OH)—P(═O)(OH)—C(OH)(carboxyalkyl)(carboxyalkyl),
(aryl)(alkynyl)C(OH)—P(═O)(OH)—C(OH)(alkynyl)(alkynyl),
(carboxyalkyl)(alkynyl)C(OH)—P(═O)(OH)—C(OH)(alkynyl)(alkynyl),
(alkynyl)(aryl)C(OH)—P(═O)(OH)—C(OH)(alkynyl)(alkynyl),
(aryl)(aryl)C(OH)—P(═O)(OH)—C(OH)(alkynyl)(alkynyl),
(carboxyalkyl)(aryl)C(OH)—P(═O)(OH)—C(OH)(alkynyl)(alkynyl),
(alkynyl)(carboxyalkyl)C(OH)—P(═O)(OH)—C(OH)(alkynyl)(alkynyl),
(aryl)(carboxyalkyl)C(OH)—P(═O)(OH)—C(OH)(alkynyl)(alkynyl),
(carboxyalkyl)(carboxyalkyl)C(OH)—P(═O)(OH)—C(OH)(alkynyl)(alkynyl),
(alkynyl)(H)C(OH)—P(═O)(OH)—C(OH)(aryl)(alkynyl),
(aryl)(H)C(OH)—P(═O)(OH)—C(OH)(aryl)(alkynyl),
(carboxyalkyl)(H)C(OH)—P(═O)(OH)—C(OH)(aryl)(alkynyl),
(alkynyl)(alkynyl)C(OH)—P(═O)(OH)—C(OH)(aryl)(alkynyl),
(carboxyalkyl)(alkynyl)C(OH)—P(═O)(OH)—C(OH)(aryl)(alkynyl),
(aryl)(aryl)C(OH)—P(═O)(OH)—C(OH)(aryl)(alkynyl),
(alkynyl)(carboxyalkyl)C(OH)—P(═O)(OH)—C(OH)(aryl)(alkynyl),
(aryl)(carboxyalkyl)C(OH)—P(═O)(OH)—C(OH)(aryl)(alkynyl),
(carboxyalkyl)(carboxyalkyl)C(OH)—P(═O)(OH)—C(OH)(aryl)(alkynyl),
(alkynyl)(H)C(OH)—P(═O)(OH)—C(OH)(carboxyalkyl)(alkynyl),
(aryl)(H)C(OH)—P(═O)(OH)—C(OH)(carboxyalkyl)(alkynyl),
(carboxyalkyl)(H)C(OH)—P(═O)(OH)—C(OH)(carboxyalkyl)(alkynyl),
(aryl)(aryl)C(OH)—P(═O)(OH)—C(OH)(carboxyalkyl)(alkynyl),
(aryl)(carboxyalkyl)C(OH)—P(═O)(OH)—C(OH)(carboxyalkyl)(alkynyl),
(carboxyalkyl)(carboxyalkyl)C(OH)—P(═O)(OH)—C(OH)(carboxyalkyl)(alkynyl),
(alkynyl)(H)C(OH)—P(═O)(OH)—C(OH)(aryl)(aryl),
(aryl)(alkynyl)C(OH)—P(═O)(OH)—C(OH)(aryl)(aryl),
(alkynyl)(carboxyalkyl)C(OH)—P(═O)(OH)—C(OH)(aryl)(aryl),
(alkynyl)(H)C(OH)—P(═O)(OH)—C(OH)(aryl)(carboxyalkyl),
(aryl)(alkynyl)C(OH)—P(═O)(OH)—C(OH)(aryl)(carboxyalkyl),
(carboxyalkyl)(alkynyl)C(OH)—P(═O)(OH)—C(OH)(aryl)(carboxyalkyl),
(alkynyl)(H)C(OH)—P(═O)(OH)—C(OH)(carboxyalkyl)(carboxyalkyl),
(alkynyl)(alkynyl)C(OH)—P(═O)(OH)—C(OH)(carboxyalkyl)(carboxyalkyl),
(aryl)(alkynyl)C(OH)—P(═O)(OH)—C(OH)(carboxyalkyl)(carboxyalkyl),
(carboxyalkyl)(alkynyl)C(OH)—P(═O)(OH)—C(OH)(carboxyalkyl)(carboxyalkyl),
(alkynyl)(aryl)C(OH)—P(═O)(OH)—C(OH)(carboxyalkyl)(carboxyalkyl),
(alkynyl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(aralkyl),
(H)(H)C(OH)—P(═O)(OH)—C(OH)(aralkyl)(alkyl),
(H)(H)C(OH)—P(═O)(OH)—C(OH)(aralkyl)(aralkyl),
(H)(H)C(OH)—P(═O)(OH)—C(OH)(aralkyl)(carboxyalkyl),
(H)(aralkyl)C(OH)—P(═O)(OH)—C(OH)(H)(alkyl),
(H)(alkyl)C(OH)—P(═O)(OH)—C(OH)(H)(aralkyl),
(H)(aralkyl)C(OH)—P(═O)(OH)—C(OH)(H)(carboxyalkyl),
(H)(aralkyl)C(OH)—P(═O)(OH)—C(OH)(alkyl)(alkyl),
(H)(H)C(OH)—P(═O)(OH)—C(OH)(aralkyl)(alkyl),
(H)(alkyl)C(OH)—P(═O)(OH)—C(OH)(aralkyl)(alkyl),
(H)(aralkyl)C(OH)—P(═O)(OH)—C(OH)(aralkyl)(alkyl),
(H)(carboxyalkyl)C(OH)—P(═O)(OH)—C(OH)(aralkyl)(alkyl),
(H)(aralkyl)C(OH)—P(═O)(OH)—C(OH)(carboxyalkyl)(alkyl),
(H)(H)C(OH)—P(═O)(OH)—C(OH)(aralkyl)(aralkyl),
(H)(alkyl)C(OH)—P(═O)(OH)—C(OH)(aralkyl)(aralkyl),
(H)(aralkyl)C(OH)—P(═O)(OH)—C(OH)(aralkyl)(aralkyl),
(H)(carboxyalkyl)C(OH)—P(═O)(OH)—C(OH)(aralkyl)(aralkyl),
(H)(H)C(OH)—P(═O)(OH)—C(OH)(aralkyl)(carboxyalkyl),
(H)(alkyl)C(OH)—P(═O)(OH)—C(OH)(aralkyl)(carboxyalkyl),
(H)(aralkyl)C(OH)—P(═O)(OH)—C(OH)(aralkyl)(carboxyalkyl),
(H)(carboxyalkyl)C(OH)—P(═O)(OH)—C(OH)(aralkyl)(carboxyalkyl),
(H)(aralkyl)C(OH)—P(═O)(OH)—C(OH)(carboxyalkyl)(carboxyalkyl),
(aralkyl)(alkyl)C(OH)—P(═O)(OH)—C(OH)(alkyl)(alkyl),
(alkyl)(aralkyl)C(OH)—P(═O)(OH)—C(OH)(alkyl)(alkyl),
(aralkyl)(aralkyl)C(OH)—P(═O)(OH)—C(OH)(alkyl)(alkyl),
(carboxyalkyl)(aralkyl)C(OH)—P(═O)(OH)—C(OH)(alkyl)(alkyl),
(aralkyl)(carboxyalkyl)C(OH)—P(═O)(OH)—C(OH)(alkyl)(alkyl),
(alkyl)(H)C(OH)—P(═O)(OH)—C(OH)(aralkyl)(alkyl),
(aralkyl)(H)C(OH)—P(═O)(OH)—C(OH)(aralkyl)(alkyl),
(carboxyalkyl)(H)C(OH)—P(═O)(OH)—C(OH)(aralkyl)(alkyl),
(alkyl)(alkyl)C(OH)—P(═O)(OH)—C(OH)(aralkyl)(alkyl),
(carboxyalkyl)(alkyl)C(OH)—P(═O)(OH)—C(OH)(aralkyl)(alkyl),
(aralkyl)(aralkyl)C(OH)—P(═O)(OH)—C(OH)(aralkyl)(alkyl),
(alkyl)(carboxyalkyl)C(OH)—P(═O)(OH)—C(OH)(aralkyl)(alkyl),
(aralkyl)(carboxyalkyl)C(OH)—P(═O)(OH)—C(OH)(aralkyl)(alkyl),
(carboxyalkyl)(carboxyalkyl)C(OH)—P(═O)(OH)—C(OH)(aralkyl)(alkyl),
(aralkyl)(H)C(OH)—P(═O)(OH)—C(OH)(carboxyalkyl)(alkyl),
(aralkyl)(aralkyl)C(OH)—P(═O)(OH)—C(OH)(carboxyalkyl)(alkyl),
(aralkyl)(carboxyalkyl)C(OH)—P(═O)(OH)—C(OH)(carboxyalkyl)(alkyl),
(alkyl)(H)C(OH)—P(═O)(OH)—C(OH)(aralkyl)(aralkyl),
(aralkyl)(H)C(OH)—P(═O)(OH)—C(OH)(aralkyl)(aralkyl),
(carboxyalkyl)(H)C(OH)—P(═O)(OH)—C(OH)(aralkyl)(aralkyl),
(aralkyl)(alkyl)C(OH)—P(═O)(OH)—C(OH)(aralkyl)(aralkyl),
(carboxyalkyl)(aralkyl)C(OH)—P(═O)(OH)—C(OH)(aralkyl)(aralkyl),
(alkyl)(carboxyalkyl)C(OH)—P(═O)(OH)—C(OH)(aralkyl)(aralkyl),
(aralkyl)(carboxyalkyl)C(OH)—P(═O)(OH)—C(OH)(aralkyl)(aralkyl),
(carboxyalkyl)(carboxyalkyl)C(OH)—P(═O)(OH)—C(OH)(aralkyl)(aralkyl),
(alkyl)(H)C(OH)—P(═O)(OH)—C(OH)(aralkyl)(carboxyalkyl),
(aralkyl)(H)C(OH)—P(═O)(OH)—C(OH)(aralkyl)(carboxyalkyl),
(carboxyalkyl)(H)C(OH)—P(═O)(OH)—C(OH)(aralkyl)(carboxyalkyl),
(aralkyl)(alkyl)C(OH)—P(═O)(OH)—C(OH)(aralkyl)(carboxyalkyl),
(carboxyalkyl)(alkyl)C(OH)—P(═O)(OH)—C(OH)(aralkyl)(carboxyalkyl),
(carboxyalkyl)(carboxyalkyl)C(OH)—P(═O)(OH)—C(OH)(aralkyl)(carboxyalkyl),
(aralkyl)(H)C(OH)—P(═O)(OH)—C(OH)(carboxyalkyl)(carboxyalkyl),
(aralkyl)(alkyl)C(OH)—P(═O)(OH)—C(OH)(carboxyalkyl)(carboxyalkyl),
(alkyl)(aralkyl)C(OH)—P(═O)(OH)—C(OH)(carboxyalkyl)(carboxyalkyl),
(aralkyl)(aralkyl)C(OH)—P(═O)(OH)—C(OH)(carboxyalkyl)(carboxyalkyl),
(carboxyalkyl)(aralkyl)C(OH)—P(═O)(OH)—C(OH)(carboxyalkyl)(carboxyalkyl),
(aralkyl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(alkaryl),
(H)(H)C(OH)—P(═O)(OH)—C(OH)(alkaryl)(alkyl),
(H)(H)C(OH)—P(═O)(OH)—C(OH)(alkaryl)(alkaryl),
(H)(H)C(OH)—P(═O)(OH)—C(OH)(alkaryl)(carboxyalkyl),
(H)(alkaryl)C(OH)—P(═O)(OH)—C(OH)(H)(alkyl),
(H)(alkyl)C(OH)—P(═O)(OH)—C(OH)(H)(alkaryl),
(H)(alkaryl)C(OH)—P(═O)(OH)—C(OH)(H)(carboxyalkyl),
(H)(alkaryl)C(OH)—P(═O)(OH)—C(OH)(alkyl)(alkyl),
(H)(H)C(OH)—P(═O)(OH)—C(OH)(alkaryl)(alkyl),
(H)(alkyl)C(OH)—P(═O)(OH)—C(OH)(alkaryl)(alkyl),
(H)(alkaryl)C(OH)—P(═O)(OH)—C(OH)(alkaryl)(alkyl),
(H)(carboxyalkyl)C(OH)—P(═O)(OH)—C(OH)(alkaryl)(alkyl),
(H)(alkaryl)C(OH)—P(═O)(OH)—C(OH)(carboxyalkyl)(alkyl),
(H)(H)C(OH)—P(═O)(OH)—C(OH)(alkaryl)(alkaryl),
(H)(alkyl)C(OH)—P(═O)(OH)—C(OH)(alkaryl)(alkaryl),
(H)(alkaryl)C(OH)—P(═O)(OH)—C(OH)(alkaryl)(alkaryl),
(H)(carboxyalkyl)C(OH)—P(═O)(OH)—C(OH)(alkaryl)(alkaryl),
(H)(H)C(OH)—P(═O)(OH)—C(OH)(alkaryl)(carboxyalkyl),
(H)(alkyl)C(OH)—P(═O)(OH)—C(OH)(alkaryl)(carboxyalkyl),
(H)(alkaryl)C(OH)—P(═O)(OH)—C(OH)(alkaryl)(carboxyalkyl),
(H)(carboxyalkyl)C(OH)—P(═O)(OH)—C(OH)(alkaryl)(carboxyalkyl),
(H)(alkaryl)C(OH)—P(═O)(OH)—C(OH)(carboxyalkyl)(carboxyalkyl),
(alkaryl)(alkyl)C(OH)—P(═O)(OH)—C(OH)(alkyl)(alkyl),
(alkyl)(alkaryl)C(OH)—P(═O)(OH)—C(OH)(alkyl)(alkyl),
(alkaryl)(alkaryl)C(OH)—P(═O)(OH)—C(OH)(alkyl)(alkyl),
(carboxyalkyl)(alkaryl)C(OH)—P(═O)(OH)—C(OH)(alkyl)(alkyl),
(alkaryl)(carboxyalkyl)C(OH)—P(═O)(OH)—C(OH)(alkyl)(alkyl),
(alkyl)(H)C(OH)—P(═O)(OH)—C(OH)(alkaryl)(alkyl),
(alkaryl)(H)C(OH)—P(═O)(OH)—C(OH)(alkaryl)(alkyl),
(carboxyalkyl)(H)C(OH)—P(═O)(OH)—C(OH)(alkaryl)(alkyl),
(alkyl)(alkyl)C(OH)—P(═O)(OH)—C(OH)(alkaryl)(alkyl),
(carboxyalkyl)(alkyl)C(OH)—P(═O)(OH)—C(OH)(alkaryl)(alkyl),
(alkaryl)(alkaryl)C(OH)—P(═O)(OH)—C(OH)(alkaryl)(alkyl),
(alkyl)(carboxyalkyl)C(OH)—P(═O)(OH)—C(OH)(alkaryl)(alkyl),
(alkaryl)(carboxyalkyl)C(OH)—P(═O)(OH)—C(OH)(alkaryl)(alkyl),
(carboxyalkyl)(carboxyalkyl)C(OH)—P(═O)(OH)—C(OH)(alkaryl)(alkyl),
(alkaryl)(H)C(OH)—P(═O)(OH)—C(OH)(carboxyalkyl)(alkyl),
(alkaryl)(alkaryl)C(OH)—P(═O)(OH)—C(OH)(carboxyalkyl)(alkyl),
(alkaryl)(carboxyalkyl)C(OH)—P(═O)(OH)—C(OH)(carboxyalkyl)(alkyl),
(alkyl)(H)C(OH)—P(═O)(OH)—C(OH)(alkaryl)(alkaryl),
(alkaryl)(H)C(OH)—P(═O)(OH)—C(OH)(alkaryl)(alkaryl),
(carboxyalkyl)(H)C(OH)—P(═O)(OH)—C(OH)(alkaryl)(alkaryl),
(alkaryl)(alkyl)C(OH)—P(═O)(OH)—C(OH)(alkaryl)(alkaryl),
(carboxyalkyl)(alkaryl)C(OH)—P(═O)(OH)—C(OH)(alkaryl)(alkaryl),
(alkyl)(carboxyalkyl)C(OH)—P(═O)(OH)—C(OH)(alkaryl)(alkaryl),
(alkaryl)(carboxyalkyl)C(OH)—P(═O)(OH)—C(OH)(alkaryl)(alkaryl),
(carboxyalkyl)(carboxyalkyl)C(OH)—P(═O)(OH)—C(OH)(alkaryl)(alkaryl),
(alkyl)(H)C(OH)—P(═O)(OH)—C(OH)(alkaryl)(carboxyalkyl),
(alkaryl)(H)C(OH)—P(═O)(OH)—C(OH)(alkaryl)(carboxyalkyl),
(carboxyalkyl)(H)C(OH)—P(═O)(OH)—C(OH)(alkaryl)(carboxyalkyl),
(alkaryl)(alkyl)C(OH)—P(═O)(OH)—C(OH)(alkaryl)(carboxyalkyl),
(carboxyalkyl)(alkyl)C(OH)—P(═O)(OH)—C(OH)(alkaryl)(carboxyalkyl),
(carboxyalkyl)(carboxyalkyl)C(OH)—P(═O)(OH)—C(OH)(alkaryl)(carboxyalkyl),
(alkaryl)(H)C(OH)—P(═O)(OH)—C(OH)(carboxyalkyl)(carboxyalkyl),
(alkaryl)(alkyl)C(OH)—P(═O)(OH)—C(OH)(carboxyalkyl)(carboxyalkyl),
(alkyl)(alkaryl)C(OH)—P(═O)(OH)—C(OH)(carboxyalkyl)(carboxyalkyl),
(alkaryl)(alkaryl)C(OH)—P(═O)(OH)—C(OH)(carboxyalkyl)(carboxyalkyl),
(carboxyalkyl)(alkaryl)C(OH)—P(═O)(OH)—C(OH)(carboxyalkyl)(carboxyalkyl),
(alkaryl)(carboxyalkyl)C(OH)—P(═O)(OH)—C(OH)(carboxyalkyl)(carboxyalkyl).

The following asymmetrically substituted phosphinic acids are also inventive compounds:
(H)(H)C(OH)—P(═O)(OH)—C(OH)(H)(hydroxyalkyl),
(H)(H)C(OH)—P(═O)(OH)—C(OH)(hydroxyalkyl)(alkyl),
(H)(H)C(OH)—P(═O)(OH)—C(OH)(aryl)(hydroxyalkyl),
(H)(H)C(OH)—P(═O)(OH)—C(OH)(hydroxyalkyl)(hydroxyalkyl),
(H)(hydroxyalkyl)C(OH)—P(═O)(OH)—C(OH)(H)(alkyl),
(H)(alkyl)C(OH)—P(═O)(OH)—C(OH)(H)(hydroxyalkyl),
(H)(aryl)C(OH)—P(═O)(OH)—C(OH)(H)(hydroxyalkyl),
(H)(hydroxyalkyl)C(OH)—P(═O)(OH)—C(OH)(alkyl)(alkyl),
(H)(hydroxyalkyl)C(OH)—P(═O)(OH)—C(OH)(aryl)(alkyl),
(H)(H)C(OH)—P(═O)(OH)—C(OH)(hydroxyalkyl)(alkyl),
(H)(alkyl)C(OH)—P(═O)(OH)—C(OH)(hydroxyalkyl)(alkyl),
(H)(aryl)C(OH)—P(═O)(OH)—C(OH)(hydroxyalkyl)(alkyl),
(H)(hydroxyalkyl)C(OH)—P(═O)(OH)—C(OH)(hydroxyalkyl)(alkyl),
(H)(hydroxyalkyl)C(OH)—P(═O)(OH)—C(OH)(aryl)(aryl),
(H)(H)C(OH)—P(═O)(OH)—C(OH)(aryl)(hydroxyalkyl),
(H)(alkyl)C(OH)—P(═O)(OH)—C(OH)(aryl)(hydroxyalkyl),
(H)(aryl)C(OH)—P(═O)(OH)—C(OH)(aryl)(hydroxyalkyl),
(H)(hydroxyalkyl)C(OH)—P(═O)(OH)—C(OH)(aryl)(hydroxyalkyl),
(H)(H)C(OH)—P(═O)(OH)—C(OH)(hydroxyalkyl)(hydroxyalkyl),
(H)(alkyl)C(OH)—P(═O)(OH)—C(OH)(hydroxyalkyl)(hydroxyalkyl),
(H)(aryl)C(OH)—P(═O)(OH)—C(OH)(hydroxyalkyl)(hydroxyalkyl),
(H)(hydroxyalkyl)C(OH)—P(═O)(OH)—C(OH)(hydroxyalkyl)(hydroxyalkyl),
(hydroxyalkyl)(alkyl)C(OH)—P(═O)(OH)—C(OH)(alkyl)(alkyl),
(hydroxyalkyl)(aryl)C(OH)—P(═O)(OH)—C(OH)(alkyl)(alkyl),
(alkyl)(hydroxyalkyl)C(OH)—P(═O)(OH)—C(OH)(alkyl)(alkyl),
(aryl)(hydroxyalkyl)C(OH)—P(═O)(OH)—C(OH)(alkyl)(alkyl),
(hydroxyalkyl)(hydroxyalkyl)C(OH)—P(═O)(OH)—C(OH)(alkyl)(alkyl),
(hydroxyalkyl)(H)C(OH)—P(═O)(OH)—C(OH)(aryl)(alkyl),
(hydroxyalkyl)(alkyl)C(OH)—P(═O)(OH)—C(OH)(aryl)(alkyl),
(alkyl)(hydroxyalkyl)C(OH)—P(═O)(OH)—C(OH)(aryl)(alkyl),
(aryl)(hydroxyalkyl)C(OH)—P(═O)(OH)—C(OH)(aryl)(alkyl),
(hydroxyalkyl)(hydroxyalkyl)C(OH)—P(═O)(OH)—C(OH)(aryl)(alkyl),
(alkyl)(H)C(OH)—P(═O)(OH)—C(OH)(hydroxyalkyl)(alkyl),
(aryl)(H)C(OH)—P(═O)(OH)—C(OH)(hydroxyalkyl)(alkyl),
(hydroxyalkyl)(H)C(OH)—P(═O)(OH)—C(OH)(hydroxyalkyl)(alkyl),
(aryl)(aryl)C(OH)—P(═O)(OH)—C(OH)(hydroxyalkyl)(alkyl),
(aryl)(hydroxyalkyl)C(OH)—P(═O)(OH)—C(OH)(hydroxyalkyl)(alkyl),
(hydroxyalkyl)(hydroxyalkyl)C(OH)—P(═O)(OH)—C(OH)(hydroxyalkyl)(alkyl),
(hydroxyalkyl)(H)C(OH)—P(═O)(OH)—C(OH)(aryl)(aryl),
(hydroxyalkyl)(aryl)C(OH)—P(═O)(OH)—C(OH)(aryl)(aryl),
(alkyl)(hydroxyalkyl)C(OH)—P(═O)(OH)—C(OH)(aryl)(aryl),
(aryl)(hydroxyalkyl)C(OH)—P(═O)(OH)—C(OH)(aryl)(aryl),
(hydroxyalkyl)(hydroxyalkyl)C(OH)—P(═O)(OH)—C(OH)(aryl)(aryl),
(alkyl)(H)C(OH)—P(═O)(OH)—C(OH)(aryl)(hydroxyalkyl),
(aryl)(H)C(OH)—P(═O)(OH)—C(OH)(aryl)(hydroxyalkyl),
(hydroxyalkyl)(H)C(OH)—P(═O)(OH)—C(OH)(aryl)(hydroxyalkyl),
(aryl)(alkyl)C(OH)—P(═O)(OH)—C(OH)(aryl)(hydroxyalkyl),
(hydroxyalkyl)(alkyl)C(OH)—P(═O)(OH)—C(OH)(aryl)(hydroxyalkyl),
(hydroxyalkyl)(hydroxyalkyl)C(OH)—P(═O)(OH)—C(OH)(aryl)(hydroxyalkyl),
(alkyl)(H)C(OH)—P(═O)(OH)—C(OH)(hydroxyalkyl)(hydroxyalkyl),
(aryl)(H)C(OH)—P(═O)(OH)—C(OH)(hydroxyalkyl)(hydroxyalkyl),
(hydroxyalkyl)(H)C(OH)—P(═O)(OH)—C(OH)(hydroxyalkyl)(hydroxyalkyl),
(alkyl)(alkyl)C(OH)—P(═O)(OH)—C(OH)(hydroxyalkyl)(hydroxyalkyl),
(aryl)(alkyl)C(OH)—P(═O)(OH)—C(OH)(hydroxyalkyl)(hydroxyalkyl),
(hydroxyalkyl)(alkyl)C(OH)—P(═O)(OH)—C(OH)(hydroxyalkyl)(hydroxyalkyl),
(alkyl)(aryl)C(OH)—P(═O)(OH)—C(OH)(hydroxyalkyl)(hydroxyalkyl),
(aryl)(aryl)C(OH)—P(═O)(OH)—C(OH)(hydroxyalkyl)(hydroxyalkyl),
(hydroxyalkyl)(aryl)C(OH)—P(═O)(OH)—C(OH)(hydroxyalkyl)(hydroxyalkyl),
(alkyl)(hydroxyalkyl)C(OH)—P(═O)(OH)—C(OH)(hydroxyalkyl)(hydroxyalkyl),
(aryl)(hydroxyalkyl)C(OH)—P(═O)(OH)—C(OH)(hydroxyalkyl)(hydroxyalkyl).

The following asymmetrically substituted phosphinic acids are also inventive compounds:
(H)(H)C(OH)—P(═O)(OH)—C(OH)(H)(methyl),
(H)(H)C(OH)—P(═O)(OH)—C(OH)(H)(phenyl),
(H)(H)C(OH)—P(═O)(OH)—C(OH)(H)((CH₂)₂CO₂H),
(H)(H)C(OH)—P(═O)(OH)—C(OH)(methyl)(methyl),
(H)(H)C(OH)—P(═O)(OH)—C(OH)(phenyl)(methyl),
(H)(H)C(OH)—P(═O)(OH)—C(OH)((CH₂)₂CO₂H)(methyl),
(H)(H)C(OH)—P(═O)(OH)—C(OH)(phenyl)(phenyl),
(H)(H)C(OH)—P(═O)(OH)—C(OH)(phenyl)((CH₂)₂CO₂H),
(H)(H)C(OH)—P(═O)(OH)—C(OH)((CH₂)₂CO₂H)((CH₂)₂CO₂H),
(H)(phenyl)C(OH)—P(═O)(OH)—C(OH)(H)(methyl),
(H)((CH₂)₂CO₂H)C(OH)—P(═O)(OH)—C(OH)(H)(methyl),
(H)(methyl)C(OH)—P(═O)(OH)—C(OH)(H)(phenyl),
(H)(methyl)C(OH)—P(═O)(OH)—C(OH)(H)((CH₂)₂CO₂H),
(H)(phenyl)C(OH)—P(═O)(OH)—C(OH)(H)((CH₂)₂CO₂H),
(H)(H)C(OH)—P(═O)(OH)—C(OH)(methyl)(methyl),
(H)(methyl)C(OH)—P(═O)(OH)—C(OH)(methyl)(methyl),
(H)(phenyl)C(OH)—P(═O)(OH)—C(OH)(methyl)(methyl),
(H)((CH₂)₂CO₂H)C(OH)—P(═O)(OH)—C(OH)(methyl)(methyl),
(H)(H)C(OH)—P(═O)(OH)—C(OH)(phenyl)(methyl),
(H)(methyl)C(OH)—P(═O)(OH)—C(OH)(phenyl)(methyl),
(H)(phenyl)C(OH)—P(═O)(OH)—C(OH)(phenyl)(methyl),
(H)((CH₂)₂CO₂H)C(OH)—P(═O)(OH)—C(OH)(phenyl)(methyl),
(H)(H)C(OH)—P(═O)(OH)—C(OH)((CH₂)₂CO₂H)(methyl),
(H)(methyl)C(OH)—P(═O)(OH)—C(OH)((CH₂)₂CO₂H)(methyl),
(H)(phenyl)C(OH)—P(═O)(OH)—C(OH)((CH₂)₂CO₂H)(methyl),
(H)((CH₂)₂CO₂H)C(OH)—P(═O)(OH)—C(OH)((CH₂)₂CO₂H)(methyl),
(H)(H)C(OH)—P(═O)(OH)—C(OH)(phenyl)(phenyl),
(H)(methyl)C(OH)—P(═O)(OH)—C(OH)(phenyl)(phenyl),
(H)(phenyl)C(OH)—P(═O)(OH)—C(OH)(phenyl)(phenyl),
(H)((CH₂)₂CO₂H)C(OH)—P(═O)(OH)—C(OH)(phenyl)(phenyl),
(H)(H)C(OH)—P(═O)(OH)—C(OH)(phenyl)((CH₂)₂CO₂H),
(H)(methyl)C(OH)—P(═O)(OH)—C(OH)(phenyl)((CH₂)₂CO₂H),
(H)(phenyl)C(OH)—P(═O)(OH)—C(OH)(phenyl)((CH₂)₂CO₂H),
(H)((CH₂)₂CO₂H)C(OH)—P(═O)(OH)—C(OH)(phenyl)((CH₂)₂CO₂H),
(H)(H)C(OH)—P(═O)(OH)—C(OH)((CH₂)₂CO₂H)((CH₂)₂CO₂H),
(H)(methyl)C(OH)—P(═O)(OH)—C(OH)((CH₂)₂CO₂H)((CH₂)₂CO₂H),
(H)(phenyl)C(OH)—P(═O)(OH)—C(OH)((CH₂)₂CO₂H)((CH₂)₂CO₂H),
(H)((CH₂)₂CO₂H)C(OH)—P(═O)(OH)—C(OH)((CH₂)₂CO₂H)((CH₂)₂CO₂H),
(phenyl)(methyl)C(OH)—P(═O)(OH)—C(OH)(methyl)(methyl),
((CH₂)₂CO₂H)(methyl)C(OH)—P(═O)(OH)—C(OH)(methyl)(methyl),
(methyl)(phenyl)C(OH)—P(═O)(OH)—C(OH)(methyl)(methyl),
(phenyl)(phenyl)C(OH)—P(═O)(OH)—C(OH)(methyl)(methyl),
((CH₂)₂CO₂H)(phenyl)C(OH)—P(═O)(OH)—C(OH)(methyl)(methyl),
(methyl)((CH₂)₂CO₂H)C(OH)—P(═O)(OH)—C(OH)(methyl)(methyl),
(phenyl)((CH₂)₂CO₂H)C(OH)—P(═O)(OH)—C(OH)(methyl)(methyl),
((CH₂)₂CO₂H)((CH₂)₂CO₂H)C(OH)—P(═O)(OH)—C(OH)(methyl)(methyl),
(methyl)(H)C(OH)—P(═O)(OH)—C(OH)(phenyl)(methyl),
(phenyl)(H)C(OH)—P(═O)(OH)—C(OH)(phenyl)(methyl),
((CH₂)₂CO₂H)(H)C(OH)—P(═O)(OH)—C(OH)(phenyl)(methyl),
(methyl)(methyl)C(OH)—P(═O)(OH)—C(OH)(phenyl)(methyl),
((CH₂)₂CO₂H)(methyl)C(OH)—P(═O)(OH)—C(OH)(phenyl)(methyl),
(phenyl)(phenyl)C(OH)—P(═O)(OH)—C(OH)(phenyl)(methyl),
(methyl)((CH₂)₂CO₂H)C(OH)—P(—O)(OH)—C(OH)(phenyl)(methyl),
(phenyl)((CH₂)₂CO₂H)C(OH)—P(═O)(OH)—C(OH)(phenyl)(methyl),
((CH₂)₂CO₂H)((CH₂)₂CO₂H)C(OH)—P(═O)(OH)—C(OH)(phenyl)(methyl),
(methyl)(H)C(OH)—P(═O)(OH)—C(OH)((CH₂)₂CO₂H)(methyl),
(phenyl)(H)C(OH)—P(═O)(OH)—C(OH)((CH₂)₂CO₂H)(methyl),
((CH₂)₂CO₂H)(H)C(OH)—P(═O)(OH)—C(OH)((CH₂)₂CO₂H)(methyl),
(phenyl)(phenyl)C(OH)—P(═O)(OH)—C(OH)((CH₂)₂CO₂H)(methyl),
(phenyl)((CH₂)₂CO₂H)C(OH)—P(═O)(OH)—C(OH)((CH₂)₂CO₂H)(methyl),
((CH₂)₂CO₂H)((CH₂)₂CO₂H)C(OH)—P(═O)(OH)—C(OH)((CH₂)₂CO₂H)(methyl),
(methyl)(H)C(OH)—P(═O)(OH)—C(OH)(phenyl)(phenyl),
(phenyl)(H)C(OH)—P(═O)(OH)—C(OH)(phenyl)(phenyl),
((CH₂)₂CO₂H)(H)C(OH)—P(═O)(OH)—C(OH)(phenyl)(phenyl),
(phenyl)(methyl)C(OH)—P(═O)(OH)—C(OH)(phenyl)(phenyl),
((CH₂)₂CO₂H)(phenyl)C(OH)—P(═O)(OH)—C(OH)(phenyl)(phenyl),
(methyl)((CH₂)₂CO₂H)C(OH)—P(═O)(OH)—C(OH)(phenyl)(phenyl),
(phenyl)((CH₂)₂CO₂H)C(OH)—P(═O)(OH)—C(OH)(phenyl)(phenyl),
((CH₂)₂CO₂H)((CH₂)₂CO₂H)C(OH)—P(═O)(OH)—C(OH)(phenyl)(phenyl),
(methyl)(H)C(OH)—P(═O)(OH)—C(OH)(phenyl)((CH₂)₂CO₂H),
(phenyl)(H)C(OH)—P(═O)(OH)—C(OH)(phenyl)((CH₂)₂CO₂H),
((CH₂)₂CO₂H)(H)C(OH)—P(═O)(OH)—C(OH)(phenyl)((CH₂)₂CO₂H),
(phenyl)(methyl)C(OH)—P(═O)(OH)—C(OH)(phenyl)((CH₂)₂CO₂H),
((CH₂)₂CO₂H)(methyl)C(OH)—P(═O)(OH)—C(OH)(phenyl)((CH₂)₂CO₂H),
((CH₂)₂CO₂H)((CH₂)₂CO₂H)C(OH)—P(═O)(OH)—C(OH)(phenyl)((CH₂)₂CO₂H),
(methyl)(H)C(OH)—P(═O)(OH)—C(OH)((CH₂)₂CO₂H)((CH₂)₂CO₂H),
(phenyl)(H)C(OH)—P(═O)(OH)—C(OH)((CH₂)₂CO₂H)((CH₂)₂CO₂H),
((CH₂)₂CO₂H)(H)C(OH)—P(═O)(OH)—C(OH)((CH₂)₂CO₂H)((CH₂)₂CO₂H),
(methyl)(methyl)C(OH)—P(═O)(OH)—C(OH)((CH₂)₂CO₂H)((CH₂)₂CO₂H),
(phenyl)(methyl)C(OH)—P(═O)(OH)—C(OH)((CH₂)₂CO₂H)((CH₂)₂CO₂H),
((CH₂)₂CO₂H)(methyl)C(OH)—P(═O)(OH)—C(OH)((CH₂)₂CO₂H)((CH₂)₂CO₂H),
(methyl)(phenyl)C(OH)—P(═O)(OH)—C(OH)((CH₂)₂CO₂H)((CH₂)₂CO₂H),
(phenyl)(phenyl)C(OH)—P(═O)(OH)—C(OH)((CH₂)₂CO₂H)((CH₂)₂CO₂H),
((CH₂)₂CO₂H)(phenyl)C(OH)—P(═O)(OH)—C(OH)((CH₂)₂CO₂H)((CH₂)₂CO₂H),
(methyl)((CH₂)₂CO₂H)C(OH)—P(═O)(OH)—C(OH)((CH₂)₂CO₂H)((CH₂)₂CO₂H),
(phenyl)((CH₂)₂CO₂H)C(OH)—P(═O)(OH)—C(OH)((CH₂)₂CO₂H)((CH₂)₂CO₂H),
((CH₂)₂CO₂H)((CH₂)₂CO₂H)C(OH)—P(═O)(OH)—C(OH)((CH₂)₂CO₂H)((CH₂)₂CO₂H).

The following asymmetrically substituted phosphinic acids are also inventive compounds:
(H)(H)C(OH)—P(═O)(OH)—C(OH)(H)(cyclohexyl),
(H)(H)C(OH)—P(═O)(OH)—C(OH)(cyclohexyl)(cyclohexyl),
(H)(H)C(OH)—P(═O)(OH)—C(OH)(phenyl)(cyclohexyl),
(H)(H)C(OH)—P(═O)(OH)—C(OH)((CH₂)₂CO₂H)(cyclohexyl),
(H)(phenyl)C(OH)—P(═O)(OH)—C(OH)(H)(cyclohexyl),
(H)((CH₂)₂CO₂H)C(OH)—P(═O)(OH)—C(OH)(H)(cyclohexyl),
(H)(cyclohexyl)C(OH)—P(═O)(OH)—C(OH)(H)(phenyl),
(H)(cyclohexyl)C(OH)—P(═O)(OH)—C(OH)(H)((CH₂)₂CO₂H),
(H)(H)C(OH)—P(═O)(OH)—C(OH)(cyclohexyl)(cyclohexyl),
(H)(cyclohexyl)C(OH)—P(═O)(OH)—C(OH)(cyclohexyl)(cyclohexyl),
(H)(phenyl)C(OH)—P(═O)(OH)—C(OH)(cyclohexyl)(cyclohexyl),
(H)((CH₂)₂CO₂H)C(OH)—P(═O)(OH)—C(OH)(cyclohexyl)(cyclohexyl),
(H)(H)C(OH)—P(═O)(OH)—C(OH)(phenyl)(cyclohexyl),
(H)(cyclohexyl)C(OH)—P(═O)(OH)—C(OH)(phenyl)(cyclohexyl),
(H)(phenyl)C(OH)—P(═O)(OH)—C(OH)(phenyl)(cyclohexyl),
(H)((CH₂)₂CO₂H)C(OH)—P(═O)(OH)—C(OH)(phenyl)(cyclohexyl),
(H)(H)C(OH)—P(═O)(OH)—C(OH)((CH₂)₂CO₂H)(cyclohexyl),
(H)(cyclohexyl)C(OH)—P(═O)(OH)—C(OH)((CH₂)₂CO₂H)(cyclohexyl),
(H)(phenyl)C(OH)—P(═O)(OH)—C(OH)((CH₂)₂CO₂H)(cyclohexyl),
(H)((CH₂)₂CO₂H)C(OH)—P(═O)(OH)—C(OH)((CH₂)₂CO₂H)(cyclohexyl),
(H)(cyclohexyl)C(OH)—P(═O)(OH)—C(OH)(phenyl)(phenyl),
(H)(cyclohexyl)C(OH)—P(═O)(OH)—C(OH)(phenyl)((CH₂)₂CO₂H),
(H)(cyclohexyl)C(OH)—P(═O)(OH)—C(OH)((CH₂)₂CO₂H)((CH₂)₂CO₂H),
(phenyl)(cyclohexyl)C(OH)—P(═O)(OH)—C(OH)(cyclohexyl)(cyclohexyl),
((CH₂)₂CO₂H)(cyclohexyl)C(OH)—P(═O)(OH)—C(OH)(cyclohexyl)(cyclohexyl),
(cyclohexyl)(phenyl)C(OH)—P(═O)(OH)—C(OH)(cyclohexyl)(cyclohexyl),
(phenyl)(phenyl)C(OH)—P(═O)(OH)—C(OH)(cyclohexyl)(cyclohexyl),
((CH₂)₂CO₂H)(phenyl)C(OH)—P(═O)(OH)—C(OH)(cyclohexyl)(cyclohexyl),
(cyclohexyl)((CH₂)₂CO₂H)C(OH)—P(═O)(OH)—C(OH)(cyclohexyl)(cyclohexyl),
(phenyl)((CH₂)₂CO₂H)C(OH)—P(═O)(OH)—C(OH)(cyclohexyl)(cyclohexyl),
((CH₂)₂CO₂H)((CH₂)₂CO₂H)C(OH)—P(═O)(OH)—C(OH)(cyclohexyl)(cyclohexyl),
(cyclohexyl)(H)C(OH)—P(═O)(OH)—C(OH)(phenyl)(cyclohexyl),
(phenyl)(H)C(OH)—P(═O)(OH)—C(OH)(phenyl)(cyclohexyl),
((CH₂)₂CO₂H)(H)C(OH)—P(═O)(OH)—C(OH)(phenyl)(cyclohexyl),
(cyclohexyl)(cyclohexyl)C(OH)—P(═O)(OH)—C(OH)(phenyl)(cyclohexyl),
((CH₂)₂CO₂H)(cyclohexyl)C(OH)—P(═O)(OH)—C(OH)(phenyl)(cyclohexyl),
(phenyl)(phenyl)C(OH)—P(═O)(OH)—C(OH)(phenyl)(cyclohexyl),
(cyclohexyl)((CH₂)₂CO₂H)C(OH)—P(═O)(OH)—C(OH)(phenyl)(cyclohexyl),
(phenyl)((CH₂)₂CO₂H)C(OH)—P(═O)(OH)—C(OH)(phenyl)(cyclohexyl),
((CH₂)₂CO₂H)((CH₂)₂CO₂H)C(OH)—P(═O)(OH)—C(OH)(phenyl)(cyclohexyl),
(cyclohexyl)(H)C(OH)—P(═O)(OH)—C(OH)((CH₂)₂CO₂H)(cyclohexyl),
(phenyl)(H)C(OH)—P(═O)(OH)—C(OH)((CH₂)₂CO₂H)(cyclohexyl),
((CH₂)₂CO₂H)(H)C(OH)—P(═O)(OH)—C(OH)((CH₂)₂CO₂H)(cyclohexyl),
(phenyl)(phenyl)C(OH)—P(═O)(OH)—C(OH)((CH₂)₂CO₂H)(cyclohexyl),
(phenyl)((CH₂)₂CO₂H)C(OH)—P(═O)(OH)—C(OH)((CH₂)₂CO₂H)(cyclohexyl),
((CH₂)₂CO₂H)((CH₂)₂CO₂H)C(OH)—P(═O)(OH)—C(OH)((CH₂)₂CO₂H)(cyclohexyl),
(cyclohexyl)(H)C(OH)—P(═O)(OH)—C(OH)(phenyl)(phenyl),
(phenyl)(cyclohexyl)C(OH)—P(═O)(OH)—C(OH)(phenyl)(phenyl),
(cyclohexyl)((CH₂)₂CO₂H)C(OH)—P(═O)(OH)—C(OH)(phenyl)(phenyl),
(cyclohexyl)(H)C(OH)—P(═O)(OH)—C(OH)(phenyl)((CH₂)₂CO₂H),
(phenyl)(cyclohexyl)C(OH)—P(═O)(OH)—C(OH)(phenyl)((CH₂)₂CO₂H),
((CH₂)₂CO₂H)(cyclohexyl)C(OH)—P(═O)(OH)—C(OH)(phenyl)((CH₂)₂CO₂H),
(cyclohexyl)(H)C(OH)—P(═O)(OH)—C(OH)((CH₂)₂CO₂H)((CH₂)₂CO₂H),
(cyclohexyl)(cyclohexyl)C(OH)—P(═O)(OH)—C(OH)((CH₂)₂CO₂H)((CH₂)₂CO₂H),
(phenyl)(cyclohexyl)C(OH)—P(═O)(OH)—C(OH)((CH₂)₂CO₂H)((CH₂)₂CO₂H),
((CH₂)₂CO₂H)(cyclohexyl)C(OH)—P(═O)(OH)—C(OH)((CH₂)₂CO₂H)((CH₂)₂CO₂H),
(cyclohexyl)(phenyl)C(OH)—P(═O)(OH)—C(OH)((CH₂)₂CO₂H)((CH₂)₂CO₂H),
(cyclohexyl)((CH₂)₂CO₂H)C(OH)—P(═O)(OH)—C(OH)((CH₂)₂CO₂H)((CH₂)₂CO₂H).

The following asymmetrically substituted phosphinic acids are also inventive compounds:
(H)(H)C(OH)—P(═O)(OH)—C(OH)(H)(benzyl),
(H)(H)C(OH)—P(═O)(OH)—C(OH)(benzyl)(methyl),
(H)(H)C(OH)—P(═O)(OH)—C(OH)(benzyl)(benzyl),
(H)(H)C(OH)—P(═O)(OH)—C(OH)(benzyl)((CH₂)₂CO₂H),
(H)(benzyl)C(OH)—P(═O)(OH)—C(OH)(H)(methyl),
(H)(methyl)C(OH)—P(═O)(OH)—C(OH)(H)(benzyl),
(H)(benzyl)C(OH)—P(═O)(OH)—C(OH)(H)((CH₂)₂CO₂H),
(H)(benzyl)C(OH)—P(═O)(OH)—C(OH)(methyl)(methyl),
(H)(H)C(OH)—P(═O)(OH)—C(OH)(benzyl)(methyl),
(H)(methyl)C(OH)—P(═O)(OH)—C(OH)(benzyl)(methyl),
(H)(benzyl)C(OH)—P(═O)(OH)—C(OH)(benzyl)(methyl),
(H)((CH₂)₂CO₂H)C(OH)—P(═O)(OH)—C(OH)(benzyl)(methyl),
(H)(benzyl)C(OH)—P(═O)(OH)—C(OH)((CH₂)₂CO₂H)(methyl),
(H)(H)C(OH)—P(═O)(OH)—C(OH)(benzyl)(benzyl),
(H)(methyl)C(OH)—P(═O)(OH)—C(OH)(benzyl)(benzyl),
(H)(benzyl)C(OH)—P(═O)(OH)—C(OH)(benzyl)(benzyl),
(H)((CH₂)₂CO₂H)C(OH)—P(═O)(OH)—C(OH)(benzyl)(benzyl),
(H)(H)C(OH)—P(═O)(OH)—C(OH)(benzyl)((CH₂)₂CO₂H),
(H)(methyl)C(OH)—P(═O)(OH)—C(OH)(benzyl)((CH₂)₂CO₂H),
(H)(benzyl)C(OH)—P(═O)(OH)—C(OH)(benzyl)((CH₂)₂CO₂H),
(H)((CH₂)₂CO₂H)C(OH)—P(═O)(OH)—C(OH)(benzyl)((CH₂)₂CO₂H),
(H)(benzyl)C(OH)—P(═O)(OH)—C(OH)((CH₂)₂CO₂H)((CH₂)₂CO₂H),
(benzyl)(methyl)C(OH)—P(═O)(OH)—C(OH)(methyl)(methyl),
(methyl)(benzyl)C(OH)—P(═O)(OH)—C(OH)(methyl)(methyl),
(benzyl)(benzyl)C(OH)—P(═O)(OH)—C(OH)(methyl)(methyl),
((CH₂)₂CO₂H)(benzyl)C(OH)—P(═O)(OH)—C(OH)(methyl)(methyl),
(benzyl)((CH₂)₂CO₂H)C(OH)—P(═O)(OH)—C(OH)(methyl)(methyl),
(methyl)(H)C(OH)—P(═O)(OH)—C(OH)(benzyl)(methyl),
(benzyl)(H)C(OH)—P(═O)(OH)—C(OH)(benzyl)(methyl),
((CH₂)₂CO₂H)(H)C(OH)—P(═O)(OH)—C(OH)(benzyl)(methyl),
(methyl)(methyl)C(OH)—P(═O)(OH)—C(OH)(benzyl)(methyl),
((CH₂)₂CO₂H)(methyl)C(OH)—P(═O)(OH)—C(OH)(benzyl)(methyl),
(benzyl)(benzyl)C(OH)—P(═O)(OH)—C(OH)(benzyl)(methyl),
(methyl)((CH₂)₂CO₂H)C(OH)—P(═O)(OH)—C(OH)(benzyl)(methyl),
(benzyl)((CH₂)₂CO₂H)C(OH)—P(═O)(OH)—C(OH)(benzyl)(methyl),
((CH₂)₂CO₂H)((CH₂)₂CO₂H)C(OH)—P(═O)(OH)—C(OH)(benzyl)(methyl),
(benzyl)(H)C(OH)—P(═O)(OH)—C(OH)((CH₂)₂CO₂H)(methyl),
(benzyl)(benzyl)C(OH)—P(═O)(OH)—C(OH)((CH₂)₂CO₂H)(methyl),
(benzyl)((CH₂)₂CO₂H)C(OH)—P(═O)(OH)—C(OH)((CH₂)₂CO₂H)(methyl),
(methyl)(H)C(OH)—P(═O)(OH)—C(OH)(benzyl)(benzyl),
(benzyl)(H)C(OH)—P(═O)(OH)—C(OH)(benzyl)(benzyl),
((CH₂)₂CO₂H)(H)C(OH)—P(═O)(OH)—C(OH)(benzyl)(benzyl),
(benzyl)(methyl)C(OH)—P(═O)(OH)—C(OH)(benzyl)(benzyl),
((CH₂)₂CO₂H)(benzyl)C(OH)—P(═O)(OH)—C(OH)(benzyl)(benzyl),
(methyl)((CH₂)₂CO₂H)C(OH)—P(═O)(OH)—C(OH)(benzyl)(benzyl),
(benzyl)((CH₂)₂CO₂H)C(OH)—P(═O)(OH)—C(OH)(benzyl)(benzyl),
((CH₂)₂CO₂H)((CH₂)₂CO₂H)C(OH)—P(═O)(OH)—C(OH)(benzyl)(benzyl),
(methyl)(H)C(OH)—P(═O)(OH)—C(OH)(benzyl)((CH₂)₂CO₂H),
(benzyl)(H)C(OH)—P(═O)(OH)—C(OH)(benzyl)((CH₂)₂CO₂H),
((CH₂)₂CO₂H)(H)C(OH)—P(═O)(OH)—C(OH)(benzyl)((CH₂)₂CO₂H),
(benzyl)(methyl)C(OH)—P(═O)(OH)—C(OH)(benzyl)((CH₂)₂CO₂H),
((CH₂)₂CO₂H)(methyl)C(OH)—P(═O)(OH)—C(OH)(benzyl)((CH₂)₂CO₂H),
((CH₂)₂CO₂H)((CH₂)₂CO₂H)C(OH)—P(═O)(OH)—C(OH)(benzyl)((CH₂)₂CO₂H),
(benzyl)(H)C(OH)—P(═O)(OH)—C(OH)((CH₂)₂CO₂H)((CH₂)₂CO₂H),
(benzyl)(methyl)C(OH)—P(═O)(OH)—C(OH)((CH₂)₂CO₂H)((CH₂)₂CO₂H),
(methyl)(benzyl)C(OH)—P(═O)(OH)—C(OH)((CH₂)₂CO₂H)((CH₂)₂CO₂H),
(benzyl)(benzyl)C(OH)—P(═O)(OH)—C(OH)((CH₂)₂CO₂H)((CH₂)₂CO₂H),
((CH₂)₂CO₂H)(benzyl)C(OH)—P(═O)(OH)—C(OH)((CH₂)₂CO₂H)((CH₂)₂CO₂H),
(benzyl)((CH₂)₂CO₂H)C(OH)—P(═O)(OH)—C(OH)((CH₂)₂CO₂H)((CH₂)₂CO₂H).

The following asymmetrically substituted phosphinic acids are also inventive compounds:
(H)(H)C(OH)—P(═O)(OH)—C(OH)(H)(tolyl),
(H)(H)C(OH)—P(═O)(OH)—C(OH)(tolyl)(methyl),
(H)(H)C(OH)—P(═O)(OH)—C(OH)(tolyl)(tolyl),
(H)(H)C(OH)—P(═O)(OH)—C(OH)(tolyl)((CH₂)₂CO₂H),
(H)(tolyl)C(OH)—P(═O)(OH)—C(OH)(H)(methyl),
(H)(methyl)C(OH)—P(═O)(OH)—C(OH)(H)(tolyl),
(H)(tolyl)C(OH)—P(═O)(OH)—C(OH)(H)((CH₂)₂CO₂H),
(H)(tolyl)C(OH)—P(═O)(OH)—C(OH)(methyl)(methyl),
(H)(H)C(OH)—P(═O)(OH)—C(OH)(tolyl)(methyl),
(H)(methyl)C(OH)—P(═O)(OH)—C(OH)(tolyl)(methyl),
(H)(tolyl)C(OH)—P(═O)(OH)—C(OH)(tolyl)(methyl),
(H)((CH₂)₂CO₂H)C(OH)—P(═O)(OH)—C(OH)(tolyl)(methyl),
(H)(tolyl)C(OH)—P(═O)(OH)—C(OH)((CH₂)₂CO₂H)(methyl),
(H)(H)C(OH)—P(═O)(OH)—C(OH)(tolyl)(tolyl),
(H)(methyl)C(OH)—P(═O)(OH)—C(OH)(tolyl)(tolyl),
(H)(tolyl)C(OH)—P(═O)(OH)—C(OH)(tolyl)(tolyl),
(H)((CH₂)₂CO₂H)C(OH)—P(═O)(OH)—C(OH)(tolyl)(tolyl),
(H)(H)C(OH)—P(═O)(OH)—C(OH)(tolyl)((CH₂)₂CO₂H),
(H)(methyl)C(OH)—P(═O)(OH)—C(OH)(tolyl)((CH₂)₂CO₂H),
(H)(tolyl)C(OH)—P(═O)(OH)—C(OH)(tolyl)((CH₂)₂CO₂H),
(H)((CH₂)₂CO₂H)C(OH)—P(═O)(OH)—C(OH)(tolyl)((CH₂)₂CO₂H),
(H)(tolyl)C(OH)—P(═O)(OH)—C(OH)((CH₂)₂CO₂H)((CH₂)₂CO₂H),
(tolyl)(methyl)C(OH)—P(═O)(OH)—C(OH)(methyl)(methyl),
(methyl)(tolyl)C(OH)—P(═O)(OH)—C(OH)(methyl)(methyl),
(tolyl)(tolyl)C(OH)—P(═O)(OH)—C(OH)(methyl)(methyl),
((CH₂)₂CO₂H)(tolyl)C(OH)—P(═O)(OH)—C(OH)(methyl)(methyl),
(tolyl)((CH₂)₂CO₂H)C(OH)—P(═O)(OH)—C(OH)(methyl)(methyl),
(methyl)(H)C(OH)—P(═O)(OH)—C(OH)(tolyl)(methyl),
(tolyl)(H)C(OH)—P(═O)(OH)—C(OH)(tolyl)(methyl),
((CH₂)₂CO₂H)(H)C(OH)—P(═O)(OH)—C(OH)(tolyl)(methyl),
(methyl)(methyl)C(OH)—P(═O)(OH)—C(OH)(tolyl)(methyl),
((CH₂)₂CO₂H)(methyl)C(OH)—P(═O)(OH)—C(OH)(tolyl)(methyl),
(tolyl)(tolyl)C(OH)—P(═O)(OH)—C(OH)(tolyl)(methyl),
(methyl)((CH₂)₂CO₂H)C(OH)—P(═O)(OH)—C(OH)(tolyl)(methyl),
(tolyl)((CH₂)₂CO₂H)C(OH)—P(═O)(OH)—C(OH)(tolyl)(methyl),
((CH₂)₂CO₂H)((CH₂)₂CO₂H)C(OH)—P(═O)(OH)—C(OH)(tolyl)(methyl),
(tolyl)(H)C(OH)—P(═O)(OH)—C(OH)((CH₂)₂CO₂H)(methyl),
(tolyl)(tolyl)C(OH)—P(═O)(OH)—C(OH)((CH₂)₂CO₂H)(methyl),
(tolyl)((CH₂)₂CO₂H)C(OH)—P(═O)(OH)—C(OH)((CH₂)₂CO₂H)(methyl),
(methyl)(H)C(OH)—P(═O)(OH)—C(OH)(tolyl)(tolyl),
(tolyl)(H)C(OH)—P(═O)(OH)—C(OH)(tolyl)(tolyl),
((CH₂)₂CO₂H)(H)C(OH)—P(═O)(OH)—C(OH)(tolyl)(tolyl),
(tolyl)(methyl)C(OH)—P(═O)(OH)—C(OH)(tolyl)(tolyl),
((CH₂)₂CO₂H)(tolyl)C(OH)—P(═O)(OH)—C(OH)(tolyl)(tolyl),
(methyl)((CH₂)₂CO₂H)C(OH)—P(═O)(OH)—C(OH)(tolyl)(tolyl),
(tolyl)((CH₂)₂CO₂H)C(OH)—P(═O)(OH)—C(OH)(tolyl)(tolyl),
((CH₂)₂CO₂H)((CH₂)₂CO₂H)C(OH)—P(═O)(OH)—C(OH)(tolyl)(tolyl),
(methyl)(H)C(OH)—P(═O)(OH)—C(OH)(tolyl)((CH₂)₂CO₂H),
(tolyl)(H)C(OH)—P(═O)(OH)—C(OH)(tolyl)((CH₂)₂CO₂H),
((CH₂)₂CO₂H)(H)C(OH)—P(═O)(OH)—C(OH)(tolyl)((CH₂)₂CO₂H),
(tolyl)(methyl)C(OH)—P(═O)(OH)—C(OH)(tolyl)((CH₂)₂CO₂H),
((CH₂)₂CO₂H)(methyl)C(OH)—P(═O)(OH)—C(OH)(tolyl)((CH₂)₂CO₂H),
((CH₂)₂CO₂H)((CH₂)₂CO₂H)C(OH)—P(═O)(OH)—C(OH)(tolyl)((CH₂)₂CO₂H),
(tolyl)(H)C(OH)—P(═O)(OH)—C(OH)((CH₂)₂CO₂H)((CH₂)₂CO₂H),
(tolyl)(methyl)C(OH)—P(═O)(OH)—C(OH)((CH₂)₂CO₂H)((CH₂)₂CO₂H),
(methyl)(tolyl)C(OH)—P(═O)(OH)—C(OH)((CH₂)₂CO₂H)((CH₂)₂CO₂H),
(tolyl)(tolyl)C(OH)—P(═O)(OH)—C(OH)((CH₂)₂CO₂H)((CH₂)₂CO₂H),
((CH₂)₂CO₂H)(tolyl)C(OH)—P(═O)(OH)—C(OH)((CH₂)₂CO₂H)((CH₂)₂CO₂H),
(tolyl)((CH₂)₂CO₂H)C(OH)—P(═O)(OH)—C(OH)((CH₂)₂CO₂H)((CH₂)₂CO₂H).

The following asymmetrically substituted phosphinic acids are also inventive compounds:
(H)(H)C(OH)—P(═O)(OH)—C(OH)(H)(aminophenyl),
(H)(H)C(OH)—P(═O)(OH)—C(OH)(aminophenyl)(methyl),
(H)(H)C(OH)—P(═O)(OH)—C(OH)(aminophenyl)(aminophenyl),
(H)(H)C(OH)—P(═O)(OH)—C(OH)(aminophenyl)((CH₂)₂CO₂H),
(H)(aminophenyl)C(OH)—P(═O)(OH)—C(OH)(H)(methyl),
(H)(methyl)C(OH)—P(═O)(OH)—C(OH)(H)(aminophenyl),
(H)(aminophenyl)C(OH)—P(═O)(OH)—C(OH)(H)((CH₂)₂CO₂H),
(H)(aminophenyl)C(OH)—P(═O)(OH)—C(OH)(methyl)(methyl),
(H)(H)C(OH)—P(═O)(OH)—C(OH)(aminophenyl)(methyl),
(H)(methyl)C(OH)—P(═O)(OH)—C(OH)(aminophenyl)(methyl),
(H)(aminophenyl)C(OH)—P(═O)(OH)—C(OH)(aminophenyl)(methyl),
(H)((CH₂)₂CO₂H)C(OH)—P(═O)(OH)—C(OH)(aminophenyl)(methyl),
(H)(aminophenyl)C(OH)—P(═O)(OH)—C(OH)((CH₂)₂CO₂H)(methyl),
(H)(H)C(OH)—P(═O)(OH)—C(OH)(aminophenyl)(aminophenyl),
(H)(methyl)C(OH)—P(═O)(OH)—C(OH)(aminophenyl)(aminophenyl),
(H)(aminophenyl)C(OH)—P(═O)(OH)—C(OH)(aminophenyl)(aminophenyl),
(H)((CH₂)₂CO₂H)C(OH)—P(═O)(OH)—C(OH)(aminophenyl)(aminophenyl),
(H)(H)C(OH)—P(═O)(OH)—C(OH)(aminophenyl)((CH₂)₂CO₂H),
(H)(methyl)C(OH)—P(═O)(OH)—C(OH)(aminophenyl)((CH₂)₂CO₂H),
(H)(aminophenyl)C(OH)—P(═O)(OH)—C(OH)(aminophenyl)((CH₂)₂CO₂H),
(H)((CH₂)₂CO₂H)C(OH)—P(═O)(OH)—C(OH)(aminophenyl)((CH₂)₂CO₂H),
(H)(aminophenyl)C(OH)—P(═O)(OH)—C(OH)((CH₂)₂CO₂H)((CH₂)₂CO₂H),
(aminophenyl)(methyl)C(OH)—P(═O)(OH)—C(OH)(methyl)(methyl),
(methyl)(aminophenyl)C(OH)—P(═O)(OH)—C(OH)(methyl)(methyl),
(aminophenyl)(aminophenyl)C(OH)—P(═O)(OH)—C(OH)(methyl)(methyl),
((CH₂)₂CO₂H)(aminophenyl)C(OH)—P(═O)(OH)—C(OH)(methyl)(methyl),
(aminophenyl)((CH₂)₂CO₂H)C(OH)—P(═O)(OH)—C(OH)(methyl)(methyl),
(methyl)(H)C(OH)—P(═O)(OH)—C(OH)(aminophenyl)(methyl),
(aminophenyl)(H)C(OH)—P(═O)(OH)—C(OH)(aminophenyl)(methyl),
((CH₂)₂CO₂H)(H)C(OH)—P(═O)(OH)—C(OH)(aminophenyl)(methyl),
(methyl)(methyl)C(OH)—P(═O)(OH)—C(OH)(aminophenyl)(methyl),
((CH₂)₂CO₂H)(methyl)C(OH)—P(═O)(OH)—C(OH)(aminophenyl)(methyl),
(aminophenyl)(aminophenyl)C(OH)—P(═O)(OH)—C(OH)(aminophenyl)(methyl),
(methyl)((CH₂)₂CO₂H)C(OH)—P(═O)(OH)—C(OH)(aminophenyl)(methyl),
(aminophenyl)((CH₂)₂CO₂H)C(OH)—P(═O)(OH)—C(OH)(aminophenyl)(methyl),
((CH₂)₂CO₂H)((CH₂)₂CO₂H)C(OH)—P(═O)(OH)—C(OH)(aminophenyl)(methyl),
(aminophenyl)(H)C(OH)—P(═O)(OH)—C(OH)((CH₂)₂CO₂H)(methyl),
(aminophenyl)(aminophenyl)C(OH)—P(═O)(OH)—C(OH)((CH₂)₂CO₂H)(methyl),
(aminophenyl)((CH₂)₂CO₂H)C(OH)—P(═O)(OH)—C(OH)((CH₂)₂CO₂H)(methyl),
(methyl)(H)C(OH)—P(═O)(OH)—C(OH)(aminophenyl)(aminophenyl),
(aminophenyl)(H)C(OH)—P(═O)(OH)—C(OH)(aminophenyl)(aminophenyl),
((CH₂)₂CO₂H)(H)C(OH)—P(═O)(OH)—C(OH)(aminophenyl)(aminophenyl),
(aminophenyl)(methyl)C(OH)—P(═O)(OH)—C(OH)(aminophenyl)(aminophenyl),
((CH₂)₂CO₂H)(aminophenyl)C(OH)—P(═O)(OH)—C(OH)(aminophenyl)(aminophenyl),
(methyl)((CH₂)₂CO₂H)C(OH)—P(═O)(OH)—C(OH)(aminophenyl)(aminophenyl),
(aminophenyl)((CH₂)₂CO₂H)C(OH)—P(═O)(OH)—C(OH)(aminophenyl)(aminophenyl),
((CH₂)₂CO₂H)((CH₂)₂CO₂H)C(OH)—P(═O)(OH)—C(OH)(aminophenyl)(aminophenyl),
(methyl)(H)C(OH)—P(═O)(OH)—C(OH)(aminophenyl)((CH₂)₂CO₂H),
(aminophenyl)(H)C(OH)—P(═O)(OH)—C(OH)(aminophenyl)((CH₂)₂CO₂H),
((CH₂)₂CO₂H)(H)C(OH)—P(═O)(OH)—C(OH)(aminophenyl)((CH₂)₂CO₂H),
(aminophenyl)(methyl)C(OH)—P(═O)(OH)—C(OH)(aminophenyl)((CH₂)₂CO₂H),
((CH₂)₂CO₂H)(methyl)C(OH)—P(═O)(OH)—C(OH)(aminophenyl)((CH₂)₂CO₂H),
((CH₂)₂CO₂H)((CH₂)₂CO₂H)C(OH)—P(═O)(OH)—C(OH)(aminophenyl)((CH₂)₂CO₂H),
(aminophenyl)(H)C(OH)—P(═O)(OH)—C(OH)((CH₂)₂CO₂H)((CH₂)₂CO₂H),
(aminophenyl)(methyl)C(OH)—P(═O)(OH)—C(OH)((CH₂)₂CO₂H)((CH₂)₂CO₂H),
(methyl)(aminophenyl)C(OH)—P(═O)(OH)—C(OH)((CH₂)₂CO₂H)((CH₂)₂CO₂H),
(aminophenyl)(aminophenyl)C(OH)—P(═O)(OH)—C(OH)((CH₂)₂CO₂H)((CH₂)₂CO₂H),
((CH₂)₂CO₂H)(aminophenyl)C(OH)—P(═O)(OH)—C(OH)((CH₂)₂CO₂H)((CH₂)₂CO₂H),
(aminophenyl)((CH₂)₂CO₂H)C(OH)—P(═O)(OH)—C(OH)((CH₂)₂CO₂H)((CH₂)₂CO₂H).

The following asymmetrically substituted phosphinic acids are also inventive compounds:
(H)(H)C(OH)—P(═O)(OH)—C(OH)(H)(CH₂OH),
(H)(H)C(OH)—P(═O)(OH)—C(OH)(CH₂OH)(methyl),
(H)(H)C(OH)—P(═O)(OH)—C(OH)(phenyl)(CH₂OH),
(H)(H)C(OH)—P(═O)(OH)—C(OH)(CH₂OH)(CH₂OH),
(H)(CH₂OH)C(OH)—P(═O)(OH)—C(OH)(H)(methyl),
(H)(methyl)C(OH)—P(═O)(OH)—C(OH)(H)(CH₂OH),
(H)(phenyl)C(OH)—P(═O)(OH)—C(OH)(H)(CH₂OH),
(H)(CH₂OH)C(OH)—P(═O)(OH)—C(OH)(methyl)(methyl),
(H)(CH₂OH)C(OH)—P(═O)(OH)—C(OH)(phenyl)(methyl),
(H)(H)C(OH)—P(═O)(OH)—C(OH)(CH₂OH)(methyl),
(H)(methyl)C(OH)—P(═O)(OH)—C(OH)(CH₂OH)(methyl),
(H)(phenyl)C(OH)—P(═O)(OH)—C(OH)(CH₂OH)(methyl),
(H)(CH₂OH)C(OH)—P(═O)(OH)—C(OH)(CH₂OH)(methyl),
(H)(CH₂OH)C(OH)—P(═O)(OH)—C(OH)(phenyl)(phenyl),
(H)(H)C(OH)—P(═O)(OH)—C(OH)(phenyl)(CH₂OH),
(H)(methyl)C(OH)—P(═O)(OH)—C(OH)(phenyl)(CH₂OH),
(H)(phenyl)C(OH)—P(═O)(OH)—C(OH)(phenyl)(CH₂OH),
(H)(CH₂OH)C(OH)—P(═O)(OH)—C(OH)(phenyl)(CH₂OH),
(H)(H)C(OH)—P(═O)(OH)—C(OH)(CH₂OH)(CH₂OH),
(H)(methyl)C(OH)—P(═O)(OH)—C(OH)(CH₂OH)(CH₂OH),
(H)(phenyl)C(OH)—P(═O)(OH)—C(OH)(CH₂OH)(CH₂OH),
(H)(CH₂OH)C(OH)—P(═O)(OH)—C(OH)(CH₂OH)(CH₂OH),
(CH₂OH)(methyl)C(OH)—P(═O)(OH)—C(OH)(methyl)(methyl),
(CH₂OH)(phenyl)C(OH)—P(═O)(OH)—C(OH)(methyl)(methyl),
(methyl)(CH₂OH)C(OH)—P(═O)(OH)—C(OH)(methyl)(methyl),
(phenyl)(CH₂OH)C(OH)—P(═O)(OH)—C(OH)(methyl)(methyl),
(CH₂OH)(CH₂OH)C(OH)—P(═O)(OH)—C(OH)(methyl)(methyl),
(CH₂OH)(H)C(OH)—P(═O)(OH)—C(OH)(phenyl)(methyl),
(CH₂OH)(methyl)C(OH)—P(═O)(OH)—C(OH)(phenyl)(methyl),
(methyl)(CH₂OH)C(OH)—P(═O)(OH)—C(OH)(phenyl)(methyl),
(phenyl)(CH₂OH)C(OH)—P(═O)(OH)—C(OH)(phenyl)(methyl),
(CH₂OH)(CH₂OH)C(OH)—P(═O)(OH)—C(OH)(phenyl)(methyl),
(methyl)(H)C(OH)—P(═O)(OH)—C(OH)(CH₂OH)(methyl),
(phenyl)(H)C(OH)—P(═O)(OH)—C(OH)(CH₂OH)(methyl),
(CH₂OH)(H)C(OH)—P(═O)(OH)—C(OH)(CH₂OH)(methyl),
(phenyl)(phenyl)C(OH)—P(═O)(OH)—C(OH)(CH₂OH)(methyl),
(phenyl)(CH₂OH)C(OH)—P(═O)(OH)—C(OH)(CH₂OH)(methyl),
(CH₂OH)(CH₂OH)C(OH)—P(═O)(OH)—C(OH)(CH₂OH)(methyl),
(CH₂OH)(H)C(OH)—P(═O)(OH)—C(OH)(phenyl)(phenyl),
(CH₂OH)(phenyl)C(OH)—P(═O)(OH)—C(OH)(phenyl)(phenyl),
(methyl)(CH₂OH)C(OH)—P(═O)(OH)—C(OH)(phenyl)(phenyl),
(phenyl)(CH₂OH)C(OH)—P(═O)(OH)—C(OH)(phenyl)(phenyl),
(CH₂OH)(CH₂OH)C(OH)—P(═O)(OH)—C(OH)(phenyl)(phenyl),
(methyl)(H)C(OH)—P(═O)(OH)—C(OH)(phenyl)(CH₂OH),
(phenyl)(H)C(OH)—P(═O)(OH)—C(OH)(phenyl)(CH₂OH),
(CH₂OH)(H)C(OH)—P(═O)(OH)—C(OH)(phenyl)(CH₂OH),
(phenyl)(methyl)C(OH)—P(═O)(OH)—C(OH)(phenyl)(CH₂OH),
(CH₂OH)(methyl)C(OH)—P(═O)(OH)—C(OH)(phenyl)(CH₂OH),
(CH₂OH)(CH₂OH)C(OH)—P(═O)(OH)—C(OH)(phenyl)(CH₂OH),
(methyl)(H)C(OH)—P(═O)(OH)—C(OH)(CH₂OH)(CH₂OH),
(phenyl)(H)C(OH)—P(═O)(OH)—C(OH)(CH₂OH)(CH₂OH),
(CH₂OH)(H)C(OH)—P(═O)(OH)—C(OH)(CH₂OH)(CH₂OH),
(methyl)(methyl)C(OH)—P(═O)(OH)—C(OH)(CH₂OH)(CH₂OH),
(phenyl)(methyl)C(OH)—P(═O)(OH)—C(OH)(CH₂OH)(CH₂OH),
(CH₂OH)(methyl)C(OH)—P(═O)(OH)—C(OH)(CH₂OH)(CH₂OH),
(methyl)(phenyl)C(OH)—P(═O)(OH)—C(OH)(CH₂OH)(CH₂OH),
(phenyl)(phenyl)C(OH)—P(═O)(OH)—C(OH)(CH₂OH)(CH₂OH),
(CH₂OH)(phenyl)C(OH)—P(═O)(OH)—C(OH)(CH₂OH)(CH₂OH),
(methyl)(CH₂OH)C(OH)—P(═O)(OH)—C(OH)(CH₂OH)(CH₂OH),
(phenyl)(CH₂OH)C(OH)—P(═O)(OH)—C(OH)(CH₂OH)(CH₂OH).

Preferred alkali metal hypophosphites which can be used in the inventive process for preparation of the asymmetrically substituted phosphinic acids are sodium hypophosphites and potassium hypophosphites.

Preferred alkaline earth metal hypophosphites are magnesium hypophosphites and calcium hypophosphites. Aluminum hypophosphite is preferred hypophosphite of the elements of the third main group.

Preferred esters of hypophosphorous acid are methyl, ethyl, n-propyl, isopropyl, n-butyl, isobutyl, tert-butyl, n-amyl, isoamyl, hexyl-, n-octyl, and ethylhexyl ester.

The reaction time is preferably from 0.01 to 1000 h, particularly preferably from 0.5 to 18 h.

The reaction temperature is preferably from −20 to +500° C., particularly preferably from 70 to 160° C.

The reaction preferably takes place in an acidic medium. The molar ratio of acid to phosphorus source is from 0:1 to 4:1, particularly preferably from 1:1 to 3:1.

The phosphorus source and/or reactant A and, respectively, B can utilize acid functions. Acid can preferably be added additionally. Particularly preferred added acids are mineral acids and/or carboxylic acids.

Preferred mineral acids are hydrohalic acids, oxo acids of the elements of the seventh main group, oxo acids of the elements of the sixth main group, oxo acids of the elements of the fifth main group, and oxo acids of the elements of the third main group. Particularly preferred mineral acids are hydrochloric acid, sulfuric acid, and/or phosphoric acid. Particularly preferred carboxylic acids are formic acid and/or acetic acid.

The reaction preferably takes place in an aqueous medium. The molar ratio of water to phosphorus source is preferably from 0:1 to 20:1.

Solvent can preferably be added to the reaction mixture. The molar ratio of solvent to phosphorus source is preferably from 0:1 to 30:1.

Preferred suitable solvents are alcohols, e.g. methanol, ethanol, isopropanol, n-propanol, n-butanol, isobutanol, tert-butanol, n-amyl alcohol, isoamyl alcohol, tert-amyl alcohol, n-hexanol, n-octanol, isooctanol, n-tridecanol, benzyl alcohol, etc. Preference is further given to glycols, e.g. ethylene glycol, 1,2-propanediol, 1,3-propanediol, 1,3-butanediol, 1,4-butanediol, diethylene glycol, etc.; aliphatic hydrocarbons, such as pentane, hexane, heptane, octane, and petroleum ether, low-boiling-point petroleum spirit, kerosene, petroleum, paraffin oil, etc.; aromatic hydrocarbons, such as benzene, tolulene, xylene, mesitylene, ethylbenzene, diethylbenzene, etc.; halogenated hydrocarbons, such as methylene chloride, chloroform, 1,2-dichloroethane, chlorobenzene, carbon tetrachloride, tetrabromoethylene, etc.; alicyclic hydrocarbons, such as cyclopentane, cyclohexane, and methylcyclohexane, etc.; ethers, such as anisole (methyl phenyl ether), tert-butyl methyl ether, dibenzyl ether, diethyl ether, dioxane, diphenyl ether, methyl vinyl ether, tetrahydrofuran, triisopropyl ether, etc.; glycol ethers, such as diethylene glycol diethyl ether, diethylene glycol dimethyl ether (diglyme), diethylene glycol monobutyl ether, diethylene glycol monomethyl ether, 1,2-dimethoxyethane (DME monoglyme), ethylene glycol monobutyl ether, triethylene glycol dimethyl ether (triglyme), triethylene glycol monomethyl ether etc.; ketones, such as acetone, diisobutyl ketone, methyl n-propyl ketone; methyl ethyl ketone, methyl isobutyl ketone, etc; esters, such as methyl formate, methyl acetate, ethyl acetate, n-propyl acetate, and n-butyl acetate, etc. It is possible to use one or more of these compounds, alone or in combination.

Particularly preferred solvents are water, alcohols, glycols, aromatics, aliphatics, cycloaliphatics, ethers, glycol ethers, ketones, esters, chlorinated hydrocarbons, and aromatics, or a mixture thereof.

Various processes can be used to prepare the inventive asymmetrical phosphinic acids.

In the following processes (1)-(3)
in each case the molar ratio of reactant A to the phosphorus source is from 0.5:1 to 10:1, preferably from 1:1 to 3:1;
in each case the molar ratio of reactant B to the phosphorus source is from 0.5:1 to 10:1, preferably from 1:1 to 3:1;
the reaction time is from 0.01 to 1000 h, preferably from 0.5 to 8 h;
the reaction temperature is from −20 to +500° C., preferably from 100 to 150° C.;
the reaction preferably takes place in an acidic medium, the molar ratio of acid to the phosphorus source being from 0:1 to 4:1, preferably from 1:1 to 3:1;
the reaction preferably takes place in an aqueous medium, the molar ratio of water to the phosphorus source being from 0:1 to 20:1, preferably from 4:1 to 15:1;
solvent can be added to the reaction mixture, the molar ratio of solvent to the phosphorus source being from 0:1 to 20:1.

In the process (1), the phosphorus source is a salt of hypophosphorous acid, and this is reacted simultaneously or in succession with reactant A and reactant B, and then the adduct is converted into the acid form via addition of mineral acids and/or carboxylic acids.

Optionally, the conversion can take place in a solvent, and/or the acid form of the adduct can be isolated from salts via solid-liquid separation, and/or separated from solvent and, respectively, by-products via thermal separation processes.

Each of these steps takes place at a pressure of from 10 to 100 000 000 Pa, for a period of from 0.01 to 1000 h and at a temperature of from −20 to +500° C., preferably at from 50 to 350° C., the molar ratio of phosphorus source to solvent being from 10:1 to 1:100.

In a process (2), the phosphorus source is a salt of hypophosphorous acid, to which mineral acids and/or carboxylic acids are added, and salts are isolated via solid-liquid separation processes, and then a reaction is carried out simultaneously or in succession with reactant A and reactant B.

Optionally, the acid form of the adduct can be separated via thermal separation processes from acid, solvent, and, respectively, by-products.

Each of these steps take place at a pressure of from 10 to 100 000 000 Pa, for a period of from 0.01 to 1000 h and at a temperature of from −20 to +500° C., preferably at from 50 to 350° C.

In the process (3), in which the phosphorus source is a salt of hypophosphorous acid, this is reacted simultaneously or in succession with reactant A and reactant B.

Optionally, an excess of acid can be removed in a neutralization process by adding alkalis. The material present then comprises the adduct only in the acid form. Optionally, the neutralization process can take place in a solvent and/or salts can be isolated via a solid-liquid separation process, and the acid form of the adduct can be separated via thermal separation processes from acid, solvent, and, respectively, by-products.

Each of these steps takes place at a pressure of from 10 to 100 000 000 Pa, for a period of from 0.01 to 1000 h and at a temperature of from −20 to +500° C., preferably at from 50 to 350° C., the molar ratio of phosphorus source to solvent being from 10:1 to 1:100. The molar ratio of alkalis to phosphorus source is preferably from 1:1 to 3:1, particularly preferably from 0:1 to 2:1.

In the processes (4a) to (4c) below,
in each case the molar ratio of reactant A to the phosphorus source is from 0.5:1 to 10:1, preferably from 1:1 to 3:1;
in each case the molar ratio of reactant B to the phosphorus source is from 0.5:1 to 10:1, preferably from 1:1 to 3:1;
the reaction time is from 0.01 to 1000 h, preferably from 0.5 to 18 h;
the reaction temperature is from −20 to +500° C., preferably from 100 to 150° C.;
the reaction preferably takes place in an acidic medium, the molar ratio of acid to the phosphorus source being from 0:1 to 4:1, preferably from 1:1 to 3:1;
the reaction preferably takes place in an aqueous medium, the molar ratio of water to the phosphorus source being from 0:1 to 20:1, preferably from 3:1 to 15:1;

In process (4a) the phosphorus source is hypophosphorous acid, and this is reacted simultaneously or in succession with reactant A and reactant B.

Optionally, the conversion can take place in a solvent, and/or the acid form of the adduct can be separated via thermal separation processes from acid, solvent, and, respectively, by-products.

Each of these steps takes place at a pressure of from 10 to 100 000 000 Pa, for a period of from 0.01 to 1000 h and at a temperature of from −20 to +500° C., preferably at from 50 to 350° C., the molar ratio of phosphorus source to solvent being from 10:1 to 1:100. The molar ratio of acid to the phosphorus source is preferably from 0:1 to 4:1, particularly preferably from 1:1 to 3:1.

The concentration of hypophosphorous acid is preferably from 1 to 100% by weight, particularly preferably from 10 to 98% by weight.

In process (4b), the acid form of the adduct can optionally also be separated via thermal separation processes from acid, solvent, and, respectively, by-products. Each of these steps takes place at a pressure of from 10 to 100 000 000 Pa, for a period of from 0.01 to 1000 h and at a temperature of from −20 to +500° C., preferably at from 50 to 350° C.

In process (4c), an excess of acid can optionally be removed in a neutralization process by adding alkalis. The material present then comprises the adduct only in the acid form. Optionally, the neutralization process can take place in a solvent and/or salts can be isolated via a solid-liquid separation process, and the acid form of the adduct can be separated via thermal separation processes from acid, solvent, and, respectively, by-products.

Each of these steps takes place at a pressure of from 10 to 100 000 000 Pa, for a period of from 0.01 to 1000 h and at a temperature of from −20 to +500° C., preferably at from 50 to 350° C., the molar ratio of phosphorus source to solvent being from 10:1 to 1:100. The molar ratio of alkalis to the phosphorus source is preferably from 0:1 to 3:1, particularly preferably from 0:1 to 2:1.

In the processes (5a) to (5c) below,
in each case the molar ratio of reactant C to the phosphorus source is from 0.5:1 to 10:1, preferably from 1:1 to 3:1;
the reaction time is from 0.01 to 1000 h, preferably from 0.5 to 8 h;
the reaction temperature is from −20 to +500° C., preferably from 78 to 150° C.;
the reaction preferably takes place in an acidic medium, the molar ratio of acid to the phosphorus source is from 0:1 to 3:1, preferably from 1:1 to 2:1;
the reaction preferably takes place in an aqueous medium, the molar ratio of water to the phosphorus source being from 0:1 to 15:1;
solvent can be added to the reaction mixture, the molar ratio of solvent to the phosphorus source being from 0:1 to 20:1.

Preference is given to a process (5a) whose phosphorus source is a monoadduct of A-P(═O)(OX)—H type, where A is R₁R₂C(OH)—, and X is H, alkali metal or ammonium, and this is reacted with reactant C to give an adduct.

Reactant C is preferably a ketone of R₃R₄C═O type, or an aldehyde of R₃CHO and/or R₄—CHO type.

In process (5b), the acid form of the adduct can optionally be separated via thermal separation processes, from acid, solvent, and respectively, by-products.

Each of these steps takes place at a pressure of from 10 to 100 000 000 Pa, for a period of from 0.01 to 1000 h and at a temperature of from −20 to +500° C., preferably at from 50 to 350° C.

In process (5c), an excess of acid can optionally be removed in a neutralization process by adding alkalis. The material present then comprises the adduct only in the acid form. Optionally, the neutralization process can take place in a solvent and/or salts can be isolated via a solid-liquid separation process, and the acid form of the adduct can be separated via thermal separation processes from acid, solvent, and, respectively, by-products.

Each of these steps takes place at a pressure of from 10 to 100 000 000 Pa, for a period of from 0.01 to 1000 h and at a temperature of from −20 to +500° C., preferably at from 50 to 350° C., the molar ratio of phosphorus source to solvent being from 10:1 to 1:100. The molar ratio of alkalis to the phosphorus source is preferably from 0:1 to 3:1, particularly preferably from 0:1 to 2:1.

Preferred uses of the inventive phosphinic acids are
as binders, e.g. for foundry materials and molding sands,
as crosslinking agents or accelerator in the hardening of epoxy resins, of
polyurethanes, or of unsaturated polyester resins,
as polymer stabilizers, e.g. as light stabilizer and/or
heat stabilizer for cotton fabrics, polymer fibers, plastics,
as crop protection agent, e.g. as plant growth regulator, or as herbicide,
pesticide, or fungicide,
as therapeutic agent or additive in therapeutic agents for humans and animals, e.g. as enzyme modulator, for stimulation of tissue growth,
as sequestering agent, e.g. for the control of deposits in industrial water supply systems, in petroleum production, and in metal-treatment agents,
as petroleum additive, e.g. as antioxidant, and for increasing octane number,
as corrosion-protection agent,
in laundry-detergent and cleaning-product applications, e.g. as decolorizer,
in electronics applications, e.g. in polyelectrolytes for capacitors, batteries, and accumulators, or else as free-radical scavengers in photosensitive layers.

It is preferable that the inventive phosphinic acid is used for preparation of flame-retardant thermoplastic polymer molding compositions.

It is preferable that the flame-retardant thermoplastic polymer molding composition comprises from 0.5 to 45% by weight of inventive phosphinic acid.

It is preferable that the flame-retardant thermoplastic polymer molding composition comprises

from 0.5 to 45% by weight of inventive phosphinic acid,
from 0.5 to 95% by weight of thermoplastic polymer, or a mixture of these,
where the entirety of the components amounts to 100% by weight.

It is preferable that the flame-retardant thermoplastic polymer molding composition comprises from 0.5 to 45% by weight of inventive phosphinic acid, from 0.5 to 95% by weight of thermoplastic polymer, or a mixture of these, from 0.5 to 55% by weight of additives, and from 0.5 to 55% by weight of filler or reinforcing materials, where the entirety of the components amounts to 100% by weight.

It is preferable that the flame-retardant thermoplastic polymer molding composition comprises from 10 to 40% by weight of inventive phosphinic acid, from 10 to 80% by weight of thermoplastic polymer, or a mixture of these, from 2 to 40% by weight of additives, and from 2 to 40% by weight of filler or reinforcing materials, where the entirety of the components amounts to 100% by weight.

The process for preparation of flame-retardant thermoplastic polymer molding compositions comprises mixing the inventive phosphinic acid with the polymer pellets and optionally with additives and incorporating it in a twin-screw extruder (ZSK 25 WLE, 14.5 kg/h, 200 rpm, L/D: 4) at temperatures of 170° C. (polystyrene), about 270° C. (PET, polyethylene terephthalate), from 230 to 260° C. (polybutylene terephthalate, PBT), 260° C. (PA6), or from 260 to 280° C. (PA 66). The homogenized polymer strand is drawn off, cooled in a water bath, and then pelletized and dried to residual moisture content of from 0.05 to 5%, preferably from 0.1 to 1% by weight.

The process for preparation of a flame-retardant thermoplastic polymer molding composition comprises polymerizing 1000 parts by weight of dimethyl terephthalate and 720 parts by weight of ethylene glycol and from 35 to 700 parts by weight of inventive phosphinic acid. The polymerization process can optionally be carried out in the presence of zinc acetate. The flame-retardant polymer molding composition can optionally be spun to give fibers.

It is preferable that the polymer is a thermoplastic or thermoset polymer.

It is preferable that the thermoplastic polymers are polymers of mono- and diolefins, for example polypropylene, polyisobutylene, poly-1-butene, poly-4-methyl-1-pentene, polyisoprene, and polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HDPE-HMW), high-density ultra high-molecular-weight polyethylene (HDPE-UHMW), medium-density polyethylene (MDPE), low-density polyethylene (LDPE), linear low-density polyethylene (LLDPE), and branched low-density polyethylene (VLDPE) or a mixture thereof.

The thermoplastic polymers preferably comprise copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

The polymers preferably comprise hydrocarbon resins (e.g. C₅-C₉), inclusive of hydrogenated modifications thereof (e.g. tackifier resins), and mixtures of polyalkylenes and starches.

The thermoplstic polymers preferably comprise polystyrene, poly(p-methylstyrene) and/or poly(alpha-methylstyrene).

The thermoplastic polymers preferably comprise copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

The thermoplastic polymers preferably comprise graft copolymers of styrene or alpha-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these, e.g. those known as ABS polymers, MBS polymers, ASA polymers, or AES polymers.

The thermoplastic polymers preferably comprise halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

The thermoplastic polymers preferably comprise polymers derived from alpha, beta-unsaturated acids or some derivatives of these, for example polyacrylates and polymethacrylates, butyl-acrylate-impact-modified polymethyl methacrylates, polyacrylamides, and polyacrylonitriles, and copolymers of the monomers mentioned with one another or with other unsaturated monomers, e.g. acrylonitrile butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

The thermoplastic polymers preferably comprise polymers derived from unsaturated alcohols or amines and, respectively, their acyl derivatives or acetals, for example polyvinyl alcohol, polyvinyl acetate, polyvinyl stearate polyvinyl benzoate, polyvinyl maleate, polyvinyl butyral, polyallyl phthalate, polyallylmelamine; or copolymers of these with olefins.

The thermoplastic polymers preferably comprise homo- or copolymers of cyclic ethers, e.g. polyalkylene glycols, polyethylene oxide, polypropylene oxide, or copolymers of these with bisglycidyl ethers.

The thermoplastic polymers preferably comprise polyacetals, such as polyoxymethylene, and polyoxymethylenes which contain comonomers, e.g. ethylene oxide; polyacetals modified with thermoplastic polyurethanes, with acrylates, or with MBS.

The thermoplastic polymers preferably comprise polyphenylene oxides or polyphenylene sulfides, or a mixture of these with styrene polymers or with polyamides.

The thermoplastic polymers preferably comprise polyurethanes derived, on the one hand, from polyethers, polyesters, or polybutadienes having terminal hydroxy groups, and, on the other hand, from aliphatic or aromatic polyisocyanates, or else precursors of these polyurethanes.

The thermoplastic polymers preferably comprise polyamides and copolyamides derived from diamines and dicarboxylic acids, and/or from aminocarboxylic acids, or from the corresponding lactams, for example nylon-4, nylon-6®Akulon K122, DSM; OZytel 7301, DuPont; ®Durethan B 29, Bayer), nylon-6,6®Zytel 101, DuPont; ®Durethan A30, ®Durethan AKV, ®Durethan AM, Bayer; ®Ultramid A3, BASF), -6,10, -6,9, -6,12, -4,6, -12,12, nylon-11, and nylon-12®Grillamid L20, Ems Chemie), aromatic polyamides based on m-xylene, diamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

The polymers preferably comprise polyureas, polyimides, polyamideimides, polyetherimides, polyesterimides, polyhydantoins, or polybenzimidazoles.

The thermoplastic polymers preferably comprise polyesters which derive from dicarboxylic acids and dialcohols and/or from hydroxycarboxylic acids, or from the corresponding lactones, for example polyethylene terephthalate, polybutylene terephthalate ®Celanex 2500, ®Celanex 2002, Celanese; ®Ultradur, BASF), poly-1,4-dimethylolcyclohexane terephthalate, polyhydroxybenzoates, and also block polyetheresters which derive from polyethers having hydroxyl end groups; as well as polyesters modified with polycarbonates or with MBS.

The thermoplastic polymers preferably comprise polycarbonates or polyester carbonates, or else polysulfones, polyether sulfones, or polyether ketones.

It is preferable that the polymers are mixtures (polyblends) of the abovementioned polymers, e.g. PP/EPDM, nylon/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/nylon-6,6 and copolymers, PA/HDPE, PA/PP, PA/PPO, PBT/PC/ABS, and PBT/PET/PC.

It is preferable that the inventive phosphinic acid is used for production of flame-retardant polymer moldings, of flame-retardant polymer films, of flame-retardant polymer filaments, or of flame-retardant polymer fibers.

It is preferable that the flame-retardant polymer moldings, flame-retardant polymer films, flame-retardant polymer filaments, and flame-retardant polymer fibers comprise from 0.5 to 45% by weight of inventive phosphinic acid and from 0.5 to 99.5% by weight of thermoplastic polymer, or a mixture of these.

It is preferable that the flame-retardant polymer moldings, flame-retardant polymer films, flame-retardant polymer filaments, and flame-retardant polymer fibers comprise from 0.5 to 45% by weight of inventive phosphinic acid and from 0.5 to 98.5% by weight of thermoplastic polymer or a mixture of these, from 0.5 to 55% by weight of additives, and from 0.5 to 55% by weight of fillers or reinforcing materials.

Finally, the invention also provides a process for production of flame-retardant polymer moldings, which comprises using injection molding (e.g. an injection-molding machine of Aarburg Allrounder type) or compression molding, foam injection molding, internal-gas-pressure injection molding, blowmolding, cast-film production, calendering, lamination, or coating, at relatively high temperatures, to process the inventive flame-retardant polymer molding compositions to give the flame-retardant polymer molding.

The process for production of flame-retardant polymer moldings comprises processing the inventive flame-retardant molding composition at suitable melt temperatures to give polymer moldings.

Suitable preferred melt temperatures are from 200 to 250° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), and from 280 to 320° C. for polycarbonate.

It is preferable that the thermoset polymers are saturated polyester resins which derive from copolyesters of saturated and unsaturated dicarboxylic acids or from their anhydrides with polyhydric alcohols, and also vinyl compounds as crosslinking agent. UP resins are hardened via free-radical polymerization using initiators (e.g. peroxides) and accelerators.

Preferred unsaturated dicarboxylic acids and their derivatives for preparation of the polyesters are maleic anhydride and fumaric acid.

Preferred saturated dicarboxylic acids are phthalic acid, isophthalic acid, terephthalic acid, tetrahydrophthalic acid, adipic acid.

Preferred diols are 1,2-propanediol, ethylene glycol, diethylene glycol, and neopentyl glycol, neopentyl glycol, and ethoxylated or propoxylated bisphenol A.

Styrene is preferred vinyl compound for the crosslinking process.

Preferred hardener systems are peroxides and metal coinitiators, e.g. hydroperoxides, and cobalt octanoate, and/or benzoyl peroxide, and aromatic amines, and/or UV light and photosensitizers, e.g. benzoin ethers.

Preferred hydroperoxides are di-tert-butyl peroxide, tert-butyl peroctoate, tert-butyl perpivalate, tert-butyl 2-ethylperhexanoate, tert-butyl permaleate, tert-butyl perisobutyrate, benzoyl peroxide, diacetyl peroxide, succinyl peroxide, p-chlorobenzoyl peroxide, dicyclohexyl peroxydicarbonate.

It is preferable to use amounts of from 0.1 to 20% by weight, with preference from 0.2 to 15% by weight, of initiators, based on the weight of all of the comonomers.

Preferred metal coinitiators are compounds of cobalt, of manganese, of iron, or vanadium, of nickel, or of lead. It is preferable to use amounts of from 0.05 to 1% by weight, based on the weight of all of the comonomers, of metal coinitiators.

Preferred aromatic amines are dimethylaniline, dimethyl-p-toluene, diethylaniline, and phenyldiethanolamines.

A process for preparation of flame-retardant copolymers comprises copolymerizing (A) at least one ethylenically unsaturated dicarboxylic anhydride, derived from at least one C₄-C₈ dicarboxylic acid, (B) at least one vinylaromatic compound and (C) a polyol, and (D) reacting with inventive phosphinic acid.

A process for preparation of flame-retardant thermoset compositions comprises mixing a thermoset resin with a flame-retardant component composed of inventive phosphinic acid, the resultant mixture being wet-pressed (cold pressing) at pressures of from 3 to 10 bar and temperatures of from 20 to 60° C.

A process for preparation of flame-retardant thermoset compositions comprises mixing a thermoset resin with inventive phosphinic acid, the resultant mixture being wet-pressed (warm or hot pressing) at pressures of from 3 to 10 bar and temperatures of from 80 to 150° C.

It is preferable that the polymers are crosslinked epoxy resins which derive from aliphatic, cycloaliphatic, heterocyclic, or aromatic glycidyl compounds, e.g. products of bisphenol A diglycidyl ethers, or of bisphenol F diglycidyl ethers, which have been crosslinked by means of conventional hardeners and/or accelerators.

Suitable glycidyl compounds are bisphenol A diglycidyl ester, bisphenol F diglycidyl ester, polyglycidyl esters of phenol-formaldehyde resins and of cresol-formaldehyde resins, polyglycidyl esters of phthalic, isophthalic, and terephthalic acid, and also of trimellitic acid, N-glycidyl compounds of aromatic amines and of heterocyclic nitrogen bases, and also di- and polyglycidyl compounds of polyhydric aliphatic alcohols.

Suitable hardeners are polyamines, such as diethylenetriamine, triethylenetetramine, aminoethylpiperazine, isophoronediamine, polyamidoamine, diaminodiphenylmethane, diaminodiphenol sulfones, and dicyandiamide.

Suitable hardeners are polybasic acids or their anhydrides, e.g. phthalic anhydride, maleic anhydride, tetrahydrophthalic anhydride, methyltetrahydrophthalic anhydride, hexahydrophthalic anhydride, and methylhexahydrophthalic anhydride.

Suitable hardeners are phenols, e.g. phenol-novolak resin, cresol-novolak resin, dicyclopentadiene-phenol-adduct resin, phenol-aralkyl resin, cresol-aralkyl resin, naphthol-aralkyl resin, biphenol-modified phenol-aralkyl resin, phenol-trimethylolmethane resin, tetraphenylolethane resin, naphthol-novolak resin, naphthol-phenol cocondensate resin, naphthol-cresol cocondensate resin, biphenol-modified phenolic resin, and aminotriazine-modified phenolic resin.

These hardeners can be used alone or in combination with one another.

Suitable catalysts or accelerators for the crosslinking process during the polymerization process are tertiary amines, benzyldimethylamine, N-alkylpyridines, imidazole, 1-methylimidazole, 2-methylimidazole, 2-ethyl-4-methylimidazole, 2-ethyl-4-methylimidazole, 2-phenylimidazole, 2-heptadecylimidazole, metal salts of organic acids, Lewis acids, and amine complex salts.

Epoxy resins are suitable for the potting of electrical or electronic components and for saturation and impregnation processes. In electrical engineering, the epoxy resins used have mainly been rendered flame-retardant and are used for printed circuit boards and for insulators.

It is preferable that the polymers are crosslinked polymers which derive on the one hand from aldehydes and on the other hand from phenols, urea, or melamine, examples being phenol-formaldehyde resins, urea-formaldehyde resins, and melamine-formaldehyde resins.

It is preferable that the polymers are crosslinkable acrylic resins which derive from substituted acrylates, e.g. from epoxy acrylates, from urethane acrylates, or from polyester acrylates.

It is preferable that the polymers are alkyd resins, polyester resins, and acrylate resins, crosslinked with melamine resins, with urea resins, with isocyanates, with isocyanurates, with polyisocyanates, or with epoxy resins.

The invention also provides a flame-retardant polyurethane molding composition prepared via reaction of from 0.1 to 50 parts by weight of inventive phosphinic acid with from 30 to 65 parts by weight of polyisocyanate and from 30 to 65 parts by weight of polyol.

The process for preparation of a flame-retardant polyurethane molding composition comprises reacting from 170 to 70 parts by weight, preferably from 130 to 80 parts by weight, of polyisocyanates with 100 parts by weight of polyol, with from 0.1 to 50 parts by weight of inventive phosphinic acid, and with from 0.1 to 4 parts by weight, particularly preferably from 1 to 2 parts by weight, of catalyst, and optionally foaming with from 0.1 to 1.8 parts by weight, preferably from 0.3 to 1.6 parts by weight, of blowing agent.

Preferred polyols are alkene oxide adducts of ethylene glycol, 1,2-propanediol, bisphenol A, trimethylolpropane, glycerol, pentaerythritol, sorbitol, sugar, degraded starch, ethylenediamine, diaminotoluene, and/or aniline, these serving as an initiator. The preferred alkoxylating agents preferably contain from 2 to 4 carbon atoms, particular preference being given to ethylene oxide and propylene oxide.

Preferred polyester polyols are obtained via polycondensation of a polyalcohol, such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, glucose, and/or sorbitol, with a dibasic acid, such as oxalic acid, malonic acid, succinic acid, tartaric acid, adipic acid, sebacic acid, maleic acid, fumaric acid, phthalic acid, terephthalic acid. These polyester polyols can be used alone or in combination.

Suitable polyisocyanates are aromatic, alicyclic, or aliphatic polyisocyanates having two or more isocyanate groups, and mixtures of these. Preference is given to aromatic polyisocyanates, such as tolyl diisocyanate, methylenediphenyl diisocyanate, naphthylene diisocyanates, xylylene diisocyanate, tris(4-isocyanatophenyl)methane, and polymethylene polyphenylene diisocyanates; alicyclic polyisocyanates are methylenediphenyl diisocyanate, tolyl diisocyanate; aliphatic polyisocyanates are hexamethylene diisocyanate, isophorene diisocyanate, demeryl diisocyanate, 1,1-methylenebis(4-isocyanatocyclohexane-4,4′-diisocyanatodicyclohexylmethane isomer mixture, cyclohexyl 1,4-diisocyanate, ®Desmodur grades (Bayer), and lysine diisocyanate, and mixtures of these.

Modified products obtained via reaction of polyisocyanate with polyol, urea, carbodiimide, and/or biuret are suitable polyisocyanates.

Suitable catalysts are strong bases, alkali metal salts of carboxylic acids, or aliphatic tertiary amines. Preference is given to quaternary ammonium hydroxide, alkali metal hydroxide or alkoxide, sodium or potassium acetate, potassium octoate, sodium benzoate, 1,4-diazabicyclo[2.2.2]octane, N,N,N′,N′-tetramethylhexamethylenediamine, N,N,N′,N′-tetramethylpropylenediamine, N,N,N′,N′,N″-pentamethyldiethylenetriamine, N,N′-di(C₁-C₂)-alkylpiperazine, trimethylaminoethylpiperazine, N,N-dimethylcyclohexylamine, N,N-dimethylbenzylamine, N-methylmorpholine, N-ethylmorpholine, trimethylamine, triethylamine, tributylamine, triethylenediamine, bis(dimethylaminoalkyl)piperazine, N,N,N′,N′-tetramethylethylenediamine, N,N-diethylbenzylamine, bis(N,N-diethylaminoethyl)adipate, N,N,N′,N′-tetramethyl-1,3-butanediamine, N,N-diethyl-[beta]phenylethylamine, 1,2-dimethylimidazole, 2-methylimidazole etc. (U.S. Pat. No. 6,878,753).

It is preferable that the ratio by weight of the polyisocyanate to polyol is from 170 to 70, preferably from 130 to 80, based on 100 parts by weight of the polyol.

It is preferable that the ratio by weight of the catalyst is from 0.1 to 4 parts by weight, particularly preferably from 1 to 2 parts by weight, based on 100 parts by weight of the polyol.

Preferred blowing agents are water, hydrocarbon, fluorochlorocarbon, fluorocarbon, etc.

The amount of the blowing agent is from 0.1 to 1.8 parts by weight, preferably from 0.3 to 1.6 parts by weight, and in particular from 0.8 to 1.6 parts by weight, based on 100 parts by weight of the polyol.

### EXAMPLE 1

### Process 3

54.2 g of hydrochloric acid (37%) and 26.4 g of paraldehyde (acetaldehyde trimer; corresponding to 0.6 mol of monomer) are admixed with 53.0 g of sodium hypophosphite monohydrate. The mixture is heated to 11° C. for 6 h, with stirring, in a Berghoff laboratory autoclave. 16.5 g of paraformaldehyde (formaldehyde trimer; corresponding to 0.55 mol of monomer) are then admixed with the cooled reaction mixture, and the mixture is heated to 154° C. for a further 0.5 h. 64 mol % content of formaldehyde-acetaldehyde adduct is determined (chemical shift 46.7 ppm) by ³¹P NMR spectroscopy. 0.05 mol of NaOH solution is then added, and the reaction solution is first evaporated to dryness and then taken up in ethanol, and precipitated sodium chloride is removed. Once the solvent has been removed by distillation, the residue comprises formaldehyde-acetaldehyde adduct in the form of crude product.

### Preparation of Hypophosphorous Acid (98%)

Commercially available hypophosphorous acid with about 50% by weight of active substance is concentrated with the aid of a rotary evaporator at subatmospheric pressure, and P content is determined analytically.

### EXAMPLE 2

### Process 4b

49.3 g of hydrochloric acid (37%) and 26.4 g of paraldehyde (acetaldehyde trimer; corresponding to 0.6 mol of monomer) are admixed with 33.7 g of hypophosphorous acid (98%). The mixture is heated to 110° C. for 18 h, with stirring, in a Berghoff laboratory autoclave. 16.5 g of paraformaldehyde (formaldehyde trimer; corresponding to 0.5 mol of monomer) are then admixed with the cooled reaction mixture, and the mixture is heated to 154° C. for a further 18 h. 60 mol % content of formaldehyde-acetaldehyde adduct is determined by ³¹P NMR spectroscopy. The reaction solution is evaporated to dryness. The residue comprises the formaldehyde-acetaldehyde adduct in the form of crude product.

### Preparation of Monoacetone Adduct (1-hydroxy-1-methylethylphosphinic acid)

741.9 g (7.0 mol) of sodium hypophosphite monohydrate are used as initial charge in a multinecked round-bottomed flask with stirrer, high-performance condenser, and dropping funnel, and 1390 g (14.1 mol) of hydrochloric acid are slowly added dropwise under a nitrogen atmosphere. 609 g (10.5 mol) of acetone are then added. The stirred mixture is slowly heated and heated at reflux for 7 hours. The reaction mixture is cooled and 672 g (8.4 mol) of NaOH in the form of (50% by weight) sodium hydroxide solution is added dropwise with stirring and ice cooling in such a way that the temperature does not rise above 50° C. After cooling to room temperature, the suspension is filtered through a suction funnel and the retentate is washed with acetone. The solvent is removed by distillation from the filtrate using a rotary evaporator at 70° C. and 20 mbar. 1000 g of ethanol are adrmixed with the residue, and sodium chloride is again removed by filtration and solvent is removed by distillation at subatmospheric pressure. The product obtained (933.2 g) is a slightly cloudy, viscous wax, comprising 87.6 mol % of monoacetone adduct (³¹P NMR; chemical shift 38.5 ppm)

### EXAMPLE 3

### Process 5b

24.6 g of hydrochloric acid (37%), 148 g of demin. water and 16.5 g of paraformaldehyde (formaldehyde trimer; corresponding to 0.55 mol of monomer) are admixed with 64 g of monoacetone adduct. The mixture is heated to 110° C. for 1 h, with stirring, in a Berghoff laboratory autoclave. 83 mol % content of acetone-formaldehyde adduct is determined in the cooled reaction mixture by ³¹P NMR spectroscopy. The reaction solution is evaporated to dryness. The residue comprises the acetone-formaldehyde adduct in the form of crude product.

### EXAMPLE 4

### Process 5a

148 g of demin. water and 24.2 g of paraldehyde (acetaldehyde trimer; corresponding to 0.55 mol of monomer) are admixed with 64 g of monoacetone adduct. The mixture is heated to 110° C. for 6 h, with stirring, in a Berghoff laboratory autoclave. 77 mol % content of acetone-acetaldehyde adduct is determined in the cooled reaction mixture by ³¹P NMR spectroscopy. The reaction solution is evaporated to dryness. The residue comprises the acetone-acetaldehyde adduct in the form of crude product.

### EXAMPLE 5

### Process 5a

39.7 g of benzaldehyde are admixed with 64 g of monoacetone adduct.

The mixture is heated to 110° C. for 6 h, with stirring, in a multinecked round-bottomed flask. 75 mol % content of acetone-benzaldehyde adduct is determined in the cooled reaction mixture by ³¹P NMR spectroscopy.

### EXAMPLE 6

### Process 3

98.5 g of hydrochloric acid (37%) and 98.2 g of cyclohexanone are admixed with 53.0 g of sodium hypophosphite monohydrate. The mixture is heated to 108° C. for 8.5 h with stirring, in a Berghoff laboratory autoclave. 16.5 g of paraformaldehyde (formaldehyde trimer; corresponding to 0.55 mol of monomer) are then admixed with the cooled reaction mixture and the mixture is heated to 11° C. for a further 6 h. 68 mol % content of cyclohexanone-formaldehyde adduct is determined by ³¹P NMR spectroscopy. 0.5 mol of NaOH solution is then added, and the reaction solution is first evaporated to dryness, and then taken up in ethanol, and precipitated sodium chloride is removed. After removal of the solvent by distillation, the residue comprises cyclohexanone-formaldehyde adduct in the form of crude product.

### EXAMPLE 7

### Process 2

29.6 g of hydrochloric acid (37%) are admixed with 15.9 g of sodium hypophosphite monohydrate. Sodium chloride which precipitates is removed by filtration. 206 g of ethanol and 35.0 g of benzaldehyde are admixed with the mother liquor, and the mixture is heated to 82° C. for 6 h, with stirring, in a Berghoff laboratory autoclave. 5 g of paraformaldehyde (formaldehyde trimer; corresponding to 0.17 mol of monomer) are then admixed with the cooled reaction mixture, and the mixture is heated to 150° C. for a further 0.5 h. 63 mol % content of benzaldehyde-formaldehyde adduct (chemical shift 41.8-44.5 ppm) is determined by ³¹P NMR spectroscopy. The reaction solution is evaporated to dryness, and the residue comprises the benzaldehyde-formaldehyde adduct in the form of crude product.

### Preparation of Monobenzaldehyde Adduct

159.0 g (1.5 mol) of sodium hypophosphite monohydrate and 295.9 g (3.0 mol) of hydrochloric acid (37% by weight) are mixed, and the resultant NaCl is removed by suction through a frit. The filtrate is used as initial charge in a 4 l multinecked flask with 2062 g of ethanol and 350.0 g (3.3 mol) of benzaldehyde. The mixture is heated at reflux (82° C.) for 6 h under nitrogen. After cooling, the solvent is first removed by distillation using a rotary evaporator at 70° C. and 20 mbar, and then excess benzaldehyde is removed by steam distillation. The aqueous solution is filtered, and the filtrate is freed from residual solvent via distillation at subatmospheric pressure. The residue of slightly yellowish resin (261 g) comprises 68% of monobenzaldehyde adduct (chemical shift 32.6 ppm ¹J_{PH}=529 Hz)

### EXAMPLE 8

### Process 5c

49.3 g of hydrochloric acid (37%) and 230 g of ethanol, and 12.1 g of paraldehyde (acetaldehyde trimer; corresponding to 0.28 mol of monomer) are admixed with 63.3 g of monobenzaldehyde adduct. The mixture is heated to 150° C. for 6 h, with stirring, in a Berghoff laboratory autoclave. 65 mol % content of benzaldehyde-acetaldehyde adduct is determined by ³¹P NMR spectroscopy. 0.5 mol of NaOH solution is then added, and the reaction solution is first evaporated to dryness and then taken up in ethanol, and precipitated sodium chloride is removed. Once the solvent has been removed by distillation, the residue comprises benzaldehyde-acetaldehyde adduct in the form of crude product.

### EXAMPLE 9

### Process 5a

230 g of ethanol and 19.3 g of methacrolein are admixed with 63.3 g of mono-benzaldehyde adduct in a multinecked round-bottomed flask. The mixture is heated at reflux at 78° C. for 3 h. 22.5 mol % content of benzaldehyde-methacrolein adduct is determined by ³¹P NMR spectroscopy in the cooled reaction mixture. The reaction solution is evaporated to dryness.

### EXAMPLE 10

### Process 2

54.2 g of hydrochloric acid (37%) are admixed with 53.0 g of sodium hypophosphite monohydrate. Sodium chloride which precipitates is removed by filtration. 72.1 g of acetophenone are admixed with the filtrate in a multinecked round-bottomed flask, and the mixture is heated at reflux at 97° C. for 8 h, with stirring. The cooled reaction solution is heated to 110° C. for 8 h with 16.5 g of paraformaldehyde (formaldehyde trimer; corresponding to 0.55 mol of monomer) in a Berghoff laboratory autoclave. 78 mol % content of acetophenone-formaldehyde adduct is determined by ³¹P NMR spectroscopy. The reaction solution is evaporated to dryness, and the residue comprises the acetophenone-formaldehyde adduct in the form of crude product.

### EXAMPLE 11

### Process 4a

68 g of demin. water and 182 g of benzophenone are admixed with 16.8 g of hypophosphorous acid (98%). The mixture is heated to 11° C. for 6.5 h, with stirring, in a Berghoff laboratory autoclave. 8.3 g of paraformaldehyde (formaldehyde trimer; corresponding to 0.28 mol of monomer) are then admixed with the cooled reaction mixture, and the mixture is heated to 110° C. for a further 8 h. 44 mol % content of benzophenone-formaldehyde adduct is determined by ³¹P NMR spectroscopy. The reaction solution is evaporated to dryness. The residue comprises the benzophenone-formaldehyde adduct in the form of crude product.

### EXAMPLE 12

### Process 1

75 g of demin. water and 0.9 mol of sodium glyoxylate are admixed with 31.8 g of sodium hypophosphite monohydrate. The sodium salt was prepared by reacting 0.9 mol of glyoxylic acid hydrate with 0.9 mol of NaOH solution. The mixture is heated to 140° C. for 19 h, with stirring, in a Berghoff laboratory autoclave. 9.9 g of paraformaldehyde (formaldehyde trimer; corresponding to 0.33 mol of monomer) are then admixed with the cooled reaction mixture, and the mixture is heated to 110° C. for a further 8 h. 42 mol % content of glyoxylic-acid-formaldehyde adduct is determined by ³¹P NMR spectroscopy. 0.6 mol of sulfuric acid (98%) is then added, and the reaction mixture is first evaporated to dryness and then taken up in ethanol, and precipitated sodium sulfate hydrate is removed. Once the solvent has been removed by distillation, the residue comprises glyoxylic acid-formaldehyde adduct in the form of crude product.

### EXAMPLE 13

### Process 2

98.5 g of hydrochloric acid (37%) are admixed with 53.0 g of sodium hypophosphite monohydrate. Sodium chloride which precipitates is removed by filtration. 58.1 g of levulinic acid are admixed with the filtrate, and the mixture is heated to 111° C. for 21 h, with stirring, in a Berghoff laboratory autoclave. 16.5 g of paraformaldehyde (formaldehyde trimer; corresponding to 0.55 mol of monomer) are admixed with the cooled reaction solution, and the mixture is heated to 110° C. for 8 h. 68 mol % content of levulinic-acid-formaldehyde adduct is determined by ³¹P NMR spectroscopy. The reaction solution is evaporated to dryness, and the residue comprises the levulinic-acid-formaldehyde adduct in the form of crude product.

### EXAMPLE 14

### Process 5c

49.3 g of hydrochloric acid (37%) and 74.1 g of hydroxyacetone are admixed with 33.7 g of hypophosphorous acid (98%). The mixture is heated to 110° C. for 3 h, with stirring, in a Berghoff laboratory autoclave. 16.5 g of paraformaldehyde (formaldehyde trimer; corresponding to 0.55 mol of monomer) are admixed with the cooled reaction mixture, and the mixture is heated to 130° C. for a further 5 h. 72 mol % content of hydroxyacetone-formaldehyde adduct is determined by ³¹P NMR spectroscopy. 0.5 mol of NaOH solution is then added, and the reaction mixture is first evaporated to dryness and then taken up in ethanol, and precipitated sodium chloride is removed. Once the solvent has been removed by distillation, the residue comprises hydroxyacetone-formaldehyde adduct in the form of crude product.

### EXAMPLE 15

### Process 3

98.5 g of hydrochloric acid (37%), 109 g of demin. water, and 67.6 g of 3′-aminoacetophenone are admixed with 53.0 g of sodium hypophosphite monohydrate. The mixture is heated to 110° C. for 14 h, with stirring, in a Berghoff laboratory autoclave. 16.5 g of paraformaldehyde (formaldehyde trimer; corresponding to 0.55 mol of monomer) are then admixed with the cooled reaction mixture, and the mixture is heated to 110° C. a further 8 h. 61 mol % content 3′-aminoacetophenone-formaldehyde adduct is determined by ³¹P NMR spectroscopy. NaOH solution is added until the pH is 10.5, and the mixture is filtered, the filtrate is evaporated to dryness and the residue is taken up in ethanol, and precipitated sodium chloride is removed. Once the solvent has been removed by distillation, the residue comprises 3′-aminoacetophenone-formaldehyde adduct in the form of crude product.

### EXAMPLE 16

### Process 5b

49.3 g of hydrochloric acid (37%) and 63.9 g of levulinic acid are admixed with 64 g of monoacetone adduct. The mixture is heated to 110° C. for 8 h, with stirring, in a Berghoff laboratory autoclave. 78 mol % content of acetone-levulinic-acid adduct is determined by ³¹P NMR spectroscopy in the cooled reaction mixture. The reaction solution is evaporated to dryness.

TABLE 1
Amounts used and experimental conditions for the examples

| | Asymmetrically substituted phosphinic | | | | | | | |
|---|---|---|---|---|---|---|---|---|
| | acid | | Reactant A | | Reactant B | | Solvent | |
| | | [g] | | [g] | | [g] | | [g] |
| 1 | Acetaldehyde-formaldehyde adduct | 21.9 | Al(OH)3 | 2.6 | | | H2O | 140 |
| 2 | Acetone-formaldehyde adduct | 92.8 | ClO | 14.0 | | | H2O | 350 |
| 3 | Acetone-acetaldehyde adduct | 109.2 | NaOH 50% | 40.0 | | | H2O | 20 |
| 4 | Acetone-butyraldehyde adduct | 130.8 | NH4OH 28% | 62.6 | | | H2O | 140 a) |
| 5 | Cyclohexanone-formaldehyde adduct | 85.7 | Zn(OH)2 | 10.1 | | | H2O | 140 |
| 6 | Benzaldehyde-formaldehyde adduct | 31.9 | NaOH 5% | 80.0 | Al2(SO4)3•14aq 46% | 13.7 | H2O | 700 |
| 7 | Benzaldehyde-acetaldehyde adduct | 166.3 | NaOH 100% | 20.0 | ZnSO4 + 7aq | 46.7 | H2O | 700 |
| 8 | Acetophenone-formaldehyde adduct | 138.6 | NaOH 50% | 40.0 | MgSO4*7aq | 48.1 | H2O | 700 |
| 9 | Acetophenone-formaldehyde adduct | 178.4 | Ti(iPrO)4 | 27.7 | | | isopr-OH | 700 |
| 10 | Levulinic-acid-formaldehyde adduct | 156.0 | Mg(OH)2 | 19.8 | | | H2O | 140 |
| 11 | Hydroxyacetone-formaldehyde adduct | 47.3 | Al | 1.8 | | | H2O | 140 |

| | T (RcA) | t (RcA) | T (RcB) | t (RcB) | p (dr) | T (dr) | t (dr) | Yield | RM | average particle | P content |
|---|---|---|---|---|---|---|---|---|---|---|---|
| Example 1 | [° C.] | [h] | [° C.] | [h] | [mbar] | [° C.] | [h] | [%] | [° C.] | size [μm] | [%] |
| 1 | 154 | 20 | — | — | 20 | 120 | 15 | 91 | 0.4 | 11 | 20.4 |
| 2 | 90 | 1 | — | — | 1013 | 120 | 15 | 50 | 0.1 | 70 | 18.0 |
| 3 | 20 | 0.2 | — | — | — | — | — | 100 | — | — | — |
| 4 | 20 | 0.5 | — | — | — | — | — | 100 | — | — | — |
| 5 | 150 | 5 | — | — | 20 | 120 | 15 | 84 | 0.1 | 150 | 13.1 |
| 6 | 50 | 0.5 | 50 | 0.2 | 1013 | 150 | 48 | 92 | 0.1 | 44 | 14.5 |
| 7 | 90 | 0.5 | 90 | 1 | 1013 | 120 | 15 | 88 | 0.2 | 92 | 12.3 |
| 8 | 90 | 0.5 | 90 | 10 | 50 | 120 | 6 | 89 | 0.6 | 273 | 13.8 |
| 9 | 82 | 10 | — | — | 1013 | 120 | 15 | 72 | 0.3 | 56 | 10.4 |
| 10 | 154 | 10 | — | — | 20 | 120 | 15 | 87 | 0.3 | 11 | 14.0 |
| 11 | 154 | 10 | — | — | 20 | 80 | 15 | 93 | 0.1 | 9 | 17.0 |

a) In addition to asymmetrically substituted phosphinic acid and/or reactant A
RcA: Reaction conditions using reactant A
RcB: Reaction conditions using reactant B
dr: Drying conditions
Yield: based on target product
RM: Residual moisture

1. An asymmetrically substituted phosphinic acid of the formula (I)
R₁R₂C(OH)—P(═O)(OX)—C(OH)R₃R₄ (I)
wherein
X is hydrogen
R₁, R₂, R₃, and R₄ are identical or different and are hydrogen, alkyl, alkenyl, alkynyl, aralkyl, aryl or alkaryl,
with the proviso that the respective R₁R₂C(OH)— and —C(OH)R₃R₄ groups are always different.

2. The asymmetrically substituted phosphinic acid as claimed in claim 1, wherein any one or more of R₁, R₂, R₃, and R₄ bear heteroatoms, have substitution by at least one functional group or both.

3. The asymmetrically substituted phosphinic acid as claimed in claim 1, wherein the at least one functional group is carbonyl, aldehyde, carboxy, hydroxy, sulfonic acid, nitrile, cyano, or epoxy groups; primary, secondary, or tertiary amino groups, unsubstituted, partially substituted, or fully substituted triazines, or a combination thereof.

4. The asymmetrically substituted phosphinic acid as claimed in claim 1, wherein the alkyl groups are methyl, ethyl, n-propyl, isopropyl, n-butyl sec-butyl, tert-butyl, n-octyl, ethylhexyl or a combination thereof.

5. The asymmetrically substituted phosphinic acid as claimed in one claim 3, wherein the carboxy groups are carboxyalkyl groups of (CH₂)ₙCO₂H where n=1-6.

6. The asymmetrically substituted phosphinic acid as claimed in claim 3, wherein the hydroxy groups are hydroxyalkyl groups of (CH₂)ₙOH where n=1-6.

7. A process for preparation of an asymmetrically substituted phosphinic acid comprising the step of reacting at least one phosphorus source simultaneously or in succession with a reactant A and with a reactant B to give an adduct.

8. The process as claimed in claim 7, wherein the at least one phosphorus source is a salt of hypophosphorous acid, hypophosphorous acid, an ester of hypophosphorous acid, or a mixture thereof.

9. The process as claimed in claim 7, wherein the salt of hypophosphorous acid is an alkali metal hypophosphite, an alkaline earth metal hypophosphite, a hypophosphite of the elements of the third main group, ammonium hypophosphite, primary, secondary, tertiary, or quaternary alkyl- or arylammonium hypophosphite, triethylammonium hypophosphite, trimethylsilylammonium hypophosphite, N-ethylpiperidine hypophosphite or a mixture thereof.

10. The process as claimed in claim 7, wherein the reactant A is a ketone of R₁R₂C═O or an aldehyde of R₁CHO, an aldehyde of R₂CHO or a mixture thereof, and the reactant B is a ketone of R₃R₄C═O, or an aldehyde of R₃CHO, an aldehyde of R₄CHO, wherein R₁, R₂, R₃, and R₄, are identical or different and are hydrogen, alkyl, alkenyl, alkynyl, aralkyl, aryl or alkaryl.

11. The process as claimed in claim 7, wherein the molar ratio of reactant A and, respectively, reactant B to the at least one phosphorus source is from 0.5:1 to 10:1.

12. A flame retardant comprising an asymmetrically substituted phosphinic acid as claimed in claim 1.

13. A flame-retardant thermoplastic polymer molding composition comprising
from 0.5 to 45% by weight of an asymmetrically substituted phosphinic acid as claimed in claim 1, and
from 0.5 to 99.5% by weight of thermoplastic polymer, or a mixture thereof, where the entirety of the components amounts to 100% by weight.

14. A flame-retardant thermoset composition, comprising
from 0.1 to 45% by weight of an asymmetrically substituted phosphinic acid according to claim 1,
from 40 to 89.9% by weight of at least one unsaturated polyester,
from 10 to 60% by weight of vinyl monomer.

15. A flame-retardant epoxy resin, comprising
from 0.5 to 50% by weight of an asymmetrically substituted phosphinic acid according to claim 1,
from 5 to 99.5% by weight of an epoxy resin,
from 0 to 20% by weight of a hardener.

16. The process as claimed in 7, wherein the molar ratio of reactant A and, respectively, reactant B to the at least one phosphorus source is from 1:1 to 5:1.

17. A composition comprising the flame retardant as claimed in claim 12, wherein the composition is a clearcoat, intumescent coating, wood, cellulose-containing products, a polymer, polymer molding compositions, flame-retardant polymer moldings, polyester, an unblended or blended cellulose textile.
